(19) United States
(12) Patent Application Publication
(10) Pub. No.: US 2025/0337919 A1
(43) Pub. Date: Oct. 30, 2025

(54) DECODING METHOD, CODING METHOD, DECODER AND CODER

(71) Applicant: GUANGDONG OPPO MOBILE TELECOMMUNICATIONS CORP., LTD., Dongguan (CN)

(72) Inventors: Lai ZHANG, Dongguan (CN); Fan WANG, Dongguan (CN)

(73) Assignee: GUANGDONG OPPO MOBILE TELECOMMUNICATIONS CORP., LTD., Dongguan (CN)

(21) Appl. No.: 19/256,918

(22) Filed: Jul. 1, 2025

Related U.S. Application Data
(63) Continuation of application No. PCT/CN2023/070229, filed on Jan. 3, 2023.

(51) Int. Cl. H04N 19/159; H04N 19/176; H04N 19/70

(52) U.S. Cl. CPC H04N 19/159; H04N 19/176; H04N 19/70

(57) ABSTRACT

Provided in the embodiments of the present application are a decoding method, a coding method, a decoder and a coder. The decoding method comprises: determining a residual block of the current block in the current sequence on the basis of a code stream; determining a first prediction block of the current block on the basis of an intra template matching prediction (IntraTMP) mode; determining a second prediction block of the current block on the basis of a first prediction mode, wherein the first prediction mode is different from the IntraTMP mode; determining a target prediction block of the current block on the basis of the first prediction block and the second prediction block; and obtaining a reconstructed block of the current block on the basis of the residual block of the current block and the target prediction block.

### CROSS-REFERENCE TO RELATED APPLICATIONS

This application is a continuation of International Application No. PCT/CN2023/070229, filed on Jan. 3, 2023, the disclosure of which is hereby incorporated by reference in its entirety.

### TECHNICAL FIELD

Embodiments of this application relate to the field of coding technologies, and more specifically, to a decoding method, an encoding method, a decoder, and an encoder.

### BACKGROUND

The digital video compression technology is mainly utilized to compress huge digital image and video data, so as to facilitate transmission, storage, and the like. Existing digital video compression standards provide a video decompression technology. With rapid increase of internet video and an increasingly high demand for video definition, a better digital video decompression technology is required, so as to improve compression efficiency.

### SUMMARY

Embodiments of this application provide a decoding method, a encoding method, a decoder, and a encoder, so as to improve decoding performance.

According to a first aspect, an embodiment of this application provides a decoding method, including:
determining a residual block of a current block in a current sequence based on a bitstream;
determining a first prediction block of the current block based on an intra template matching prediction IntraTMP mode;
determining a second prediction block of the current block based on a first prediction mode, where the first prediction mode is different from the IntraTMP mode;
determining a target prediction block of the current block based on the first prediction block and the second prediction block; and
obtaining a reconstruction block of the current block based on the residual block and the target prediction block of the current block.

According to a second aspect, an embodiment of this application provides an encoding method, including:
determining a first prediction block of a current block in a current sequence based on an intra template matching prediction IntraTMP mode;
determining a second prediction block of the current block based on a first prediction mode, where the first prediction mode is different from the IntraTMP mode;
determining a target prediction block of the current block based on the first prediction block and the second prediction block;
obtaining a residual block of the current block based on the target prediction block and an original block of the current block; and
encoding the residual block of the current block.

According to a third aspect, an embodiment of this application provides a decoder, including:
a residual unit, configured to determine a residual block of a current block in a current sequence based on a bitstream;
a first prediction unit, configured to determine a first prediction block of the current block based on an intra template matching prediction IntraTMP mode;
a second prediction unit, configured to determine a second prediction block of the current block based on a first prediction mode, where the first prediction mode is different from the IntraTMP mode;
a determining unit, configured to determine a target prediction block of the current block based on the first prediction block and the second prediction block; and
a reconstruction unit, configured to obtain a reconstruction block of the current block based on the residual block and the target prediction block of the current block.

According to a fourth aspect, an embodiment of this application provides an encoder, including:
a first prediction unit, configured to determine a first prediction block of a current block in a current sequence based on an intra template matching prediction IntraTMP mode;
a second prediction unit, configured to determine a second prediction block of the current block based on a first prediction mode, where the first prediction mode is different from the IntraTMP mode;
a determining unit, configured to determine a target prediction block of the current block based on the first prediction block and the second prediction block;
a residual unit, configured to obtain a residual block of the current block based on the target prediction block and an original block of the current block; and
an encoding unit, configured to encode the residual block of the current block.

According to a fifth aspect, an embodiment of this application provides a decoder, including:
a processor, configured to implement a computer instruction; and
a computer readable storage medium storing a computer instruction, where the computer instruction is loaded and executed by the processor to perform the decoding method according to the first aspect or implementations of the first aspect.

In an implementation, a quantity of the processor is one or more, and a quantity of the memory is one or more.

In an implementation, the computer readable storage medium may be integrated with the processor, or the computer readable storage medium is arranged separately from the processor.

According to a sixth aspect, an embodiment of this application provides an encoder, including:
a processor, configured to execute a computer instruction; and
a computer readable storage medium storing a computer instruction, where the computer instruction is loaded and executed by the processor to perform the encoding method according to the second aspect or implementations of the second aspect.

In an implementation, a quantity of the processor is one or more, and a quantity of the memory is one or more.

In an implementation, the computer readable storage medium may be integrated with the processor, or the computer readable storage medium is arranged separately from the processor.

According to a seventh aspect, an embodiment of this application provides a computer readable storage medium. The computer readable storage medium stores a computer instruction. When the computer instruction is read and executed by a processor of a computer device, the computer device performs the decoding method according to the first aspect or the encoding method according to the second aspect.

According to an eighth aspect, an embodiment of this application provides a computer program product or a computer program, where the computer program product or the computer program includes a computer instruction, and the computer instruction is stored in a computer readable storage medium. The processor of the computer device reads the computer instruction from a computer readable storage medium, and the processor executes the computer instruction, so that the computer device performs the decoding method according to the first aspect or the encoding method according to the second aspect.

According to a ninth aspect, an embodiment of this application provides a bitstream, where the bitstream is a bitstream involved in the method in the first aspect or a bitstream generated by the method in the second aspect.

### BRIEF DESCRIPTION OF DRAWINGS

FIG. 1 is a schematic block diagram of an encoding framework according to an embodiment of this application.

FIG. 2 is a schematic block diagram of a decoding framework according to an embodiment of this application.

FIG. 3 is a schematic diagram of an IntraTMP technology according to an embodiment of this application.

FIG. 4 shows an example of a template error difference between a current block and a matching block according to an embodiment of this application.

FIG. 5 shows an example of an IntraTMP technology adaption for camera-captured content according to an embodiment of this application.

FIG. 6 is a schematic diagram of a region division method for a current block according to an embodiment of this application.

FIG. 7 is a schematic flowchart of a decoding method according to an embodiment of this application.

FIG. 8 shows an example of a template of a current block according to an embodiment of this application.

FIG. 9 is a schematic flowchart of an encoding method according to an embodiment of this application.

FIG. 10 is a schematic block diagram of a decoder according to an embodiment of this application.

FIG. 11 is a schematic block diagram of an encoder according to an embodiment of this application.

FIG. 12 is a schematic block diagram of an electronic device according to an embodiment of this application.

### DESCRIPTION OF EMBODIMENTS

The following describes the technical solutions in embodiments of this application with reference to the accompanying drawings.

The solutions provided in the embodiments of this application may be applied to the field of digital video coding technologies, including but are not limited to: the field of image coding, the field of video coding, the field of hardware video coding, the field of dedicated circuit video coding, and the field of real-time video coding, for example. In addition, the solutions provided in this embodiment of this application may be combined with audio video standard (AVS), a second generation AVS standard (AVS2), or a third generation AVS standard (AVS3), for example, including but not limited to: H.264/audio video coding (AVC) standard, H.265/high efficiency video coding (HEVC) standard and H.266/versatile video coding (VVC) standard. In addition, the solution provided in this embodiment of this application may be used to perform lossy compression on the image, or may be used to perform lossless compression on the image. The lossless compression may be visually lossless compression, or may be mathematically lossless compression.

The block-based hybrid encoding framework is used for video coding standards. Specifically, each image in the video is segmented into a square largest coding unit (LCU) or coding tree unit (CTU) with the same size (e.g., 128×128, 64×64, etc.). Each largest coding unit or coding tree unit may be divided into rectangular coding unit (CU) according to rules. The coding unit may further be divided into prediction units (PU), transform units (TU), and the like. The hybrid encoding framework includes modules such as prediction, transform, quantization, entropy coding, and in-loop filtering (in loop filter). The prediction module includes intra prediction (intra prediction) and inter prediction (inter prediction). The inter prediction includes motion estimation and motion compensation. Since there is a strong correlation between adjacent pixels in an image of a video, spatial redundancy between adjacent pixels is eliminated by using an intra prediction method in a video coding technology. According to the intra prediction, the pixel information in the current division block is predicted by referring to information of the same image. Because of strong similarity between adjacent images in a video, time redundancy between adjacent images is eliminated by using an inter prediction method in the video coding technology, thereby improving encoding efficiency. According to the inter prediction, motion vector information that has a highest matching with the current division block is searched for by using motion estimation, by referring to image information of different frames. The predicted image block is transformed into a frequency domain, so that energy is redistributed. Information insensitive to a human eye can be removed by quantization, so as to eliminate visual redundancy. The entropy coding may eliminate character redundancy according to a current context model and probability information of a binary bitstream.

In a digital video coding process, the encoder may first read a black-and-white image or a color image from an original video sequence, and encode the black-and-white image or the color image. The black and white image may include pixels of luma component, and the color image may include pixels of chroma component. Optionally, the color image may further include pixels of luma component. A color format of the original video sequence may be a luma-chroma (YCbCr, YUV) format, a red-green-blue (RGB) format, or the like. Specifically, after reading a black-and-white image or a color image, the encoder divides the image into blocks, generates a prediction block of the current block by using the intra prediction or the inter prediction, subtracts the prediction block from the original block of the current block to obtain the residual block, transforms the residual block, quantizes the transformed residual block to obtain a quantization coefficient matrix, performs entropy encoding on the quantization coefficient matrix, to generate a bitstream. In the digital video decoding process, a decoding side performs prediction on the current block by using intra prediction or inter prediction to generate a prediction block of the current block. In addition, the decoding side decodes the bitstream to obtain the quantize coefficient matrix, performs inverse quantize and inverse transformation on the quantization coefficient matrix to obtain the residual block, and adds the prediction block and the residual block to obtain a reconstructed block. The reconstructed block may be used to form a reconstructed image. The decoding side performs in-loop filtering on the reconstructed image in a unit of the image or the block to obtain a decoded image.

The current block may be a current coding unit (CU), a current prediction unit (PU), or the like.

It should be noted that the encoding side also needs to perform operations similar to the decoding side to obtain the decoded image. The decoded image may be used as a reference image of the subsequent image inter prediction. Block partitioning information, mode information such as prediction, transform, quantization, entropy coding, and in-loop filtering, or parameter information determined by the encoding side, if necessary, needs to be written into the bitstream.

The decoding side determines, by parsing and analyzing the existing information, block division information, mode information such as prediction, transformation, quantization, entropy coding, and in-loop filtering, or parameter information, which is the same as corresponding information in the encoding side, thereby ensuring that the decoded image obtained by the encoding side is the same as the decoded image obtained by the decoding side. The decoded image obtained by the encoding side is generally also referred to as a reconstructed image. During prediction, the current block may be divided into prediction units. During transformation, the current block may be divided into transform units. Division of prediction unit may be the same as or different from division of the transform unit. Certainly, only a basic procedure of the video coder in the block-based hybrid encoding framework is described above. With development of the technology, some modules of the framework or some steps of the procedure may be optimized. This application is applicable to a basic procedure of the video coder in the block-based hybrid encoding framework.

For ease of understanding, the encoding framework provided in this application is first briefly described.

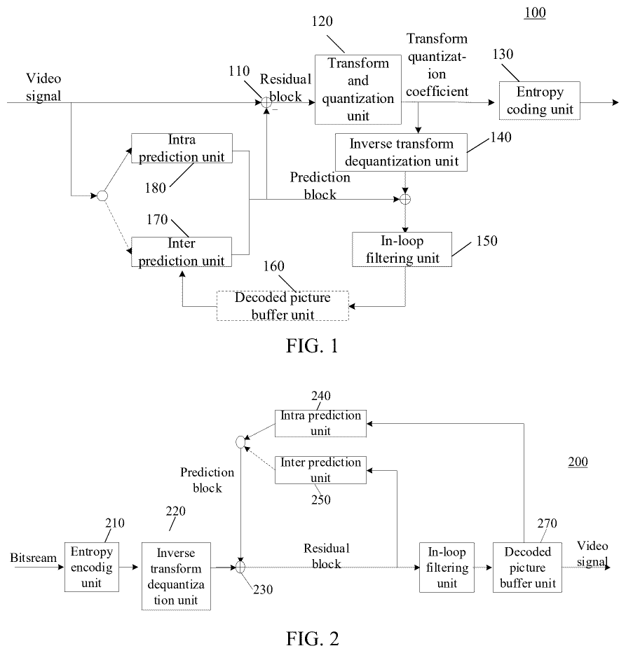

FIG. 1 is a schematic block diagram of an encoding framework 100 according to an embodiment of this application.

As shown in FIG. 1, the encoding framework 100 may include an intra prediction unit 180, an inter prediction unit 170, a residual unit 110, a transform and quantization unit 120, an entropy coding unit 130, an inverse transform and inverse quantization unit 140, and in-loop filtering unit 150. Optionally, the encoding framework 100 may further include a decoded image buffering unit 160. The encoding framework 100 may also be referred to as a hybrid framework encoding mode.

The intra prediction unit 180 or the inter prediction unit 170 may predict a to-be-encoded image block, to output a prediction block. The residual unit 110 may calculate a residual block, that is, a difference between the prediction block and the to-be-encode image block, based on the prediction block and the to-be-encoded image block. The transform and quantization unit 120 is configured to perform operations such as transform and quantization on the residual block to remove information insensitive to the human eye, thereby eliminating visual redundancy. Optionally, the residual block not subjected to transform and quantization of the transform and the quantization unit 120 may be referred to as a time domain residual block, and the residual block subjected to transform and quantization of the transform and the quantization unit 120 may be referred to as a frequency residual block or a frequency domain residual block. After receiving a transform quantization coefficient outputted by the transform and quantization unit 120, the entropy coding unit 130 may output the bitstream based on the transform quantization coefficient. For example, the entropy coding unit 130 may eliminate character redundancy according to the target context model and probability information of the binary bitstream. For example, the entropy coding unit 130 may eliminate character redundancy by using context-based adaptive binary arithmetic entropy coding (CABAC). The entropy coding unit 130 may also be referred to as header information coding unit. Optionally, in this application, the to-be-encoded image block may also be referred to as an original image block or a target image block, the prediction block may also be referred to as a prediction image block or an image prediction block, may also be referred to as a prediction signal or prediction information, and the reconstructed block may also be referred to as a reconstructed image block or an image reconstructed block, and may also be referred to as a reconstructed signal or reconstructed information. In addition, for the encoding side, the to-be-encoded image block may also be referred to as an encoding block or an encoding image block. For the decoding side, the to-be-encoded image block may also be referred to as a decoded block or a decoded image block. The to-be-encoded image block may be a CTU or a CU.

The encoding framework 100 calculates a residual block based on the predicted block and the to-be-encoded image block, performs transformation, quantization and the like on the residual block, and transmits the residual block to the decoding side. Correspondingly, after receiving the bitstream, the decoding side decodes the bitstream, obtains the residual block by performing operations such as inverse conversion and inverse quantization, and obtains a reconstructed block according to the prediction block predicted by the decoding side and the residual block.

It should be noted that the inverse conversion and inverse quantization unit 140, the in-loop filtering unit 150, and the decoded image buffering unit 160 in the encoding framework 100 may form a decoder. In this case, the intra prediction unit 180 or the inter prediction unit 170 may predict the to-be-encoded image block based on an existing reconstructed block, thereby ensuring that understanding of the reference image is consistent for the encoding side and the decoding. In other words, the encoder may replicate the processing loop of the decoder, generating the same prediction as the decoding side. Specifically, the inverse transform and inverse quantization unit 140 performs inverse transform and inverse quantization on the quantized transform coefficient, to replicate an approximate residual block of the decoding side. The approximate residual block is added to the prediction block, and then is subjected to processing of the in-loop filtering unit 150, to smoothly filter out block effects generated due to block processing and quantization. The image block outputted by the in-loop filtering unit 150 may be stored in the decoded image buffering unit 160, thereby facilitating subsequent image prediction.

It should be understood that FIG. 1 is only an example of this application, and should not be construed as a limitation to this application.

For example, the in-loop filtering unit 150 in the encoding framework 100 may include DeBlocking Filter (DBF) and Sample Adaptive Offset (SAO) filter. The DBF is configured to remove the block effect, and the SAO filter is configured to remove a ringing effect. In another embodiment of this application, the encoding framework 100 may use a neural network-based loop filter algorithm to improve video compression efficiency. Alternatively, the encoding framework 100 may be a video encoding hybrid framework of a deep learning-based neural network. In an implementation, based on the de-blocking filter and the sample adaptive offset filter, a pixel filtered result is calculated by using a convolution-based neural network model. A network structure of the in-loop filtering unit 150 may be the same or different for the luma component and the chroma component. Since the luma component contains more visual information, the luma component may be used to guide filtering of the chroma component, thereby improving reconstruction quality of the chroma component.

The following describes contents related to intra prediction and inter prediction.

According to the inter prediction, motion vector information that has a highest matching degree with the to-be-encoded image block is searched for by using motion estimation, by referring to image information of different frames, so as to eliminate time redundancy. A frame used by the inter prediction may be a P frame and/or a B frame. The P frame refers to a forward prediction frame, and the B frame refers to a bidirectional prediction frame.

According to the intra prediction, pixel information in the to-be-encoded image block is predicted by referring to information of a same image, so as to eliminate spatial redundancy. The frame used by the intra prediction may be an I frame. For example, the to-be-encoded image block may be predicted, according to an encoding sequence from left to right and from top to bottom, by referring to an upper left image block, an upper image block, and a left image block. The to-be-encoded image block is also used as reference information of a next image block. In this way, an entire image may be predicted. If the inputted digital video is in a color format, such as a YUV 4:2:0 format, every four pixels of each image frame of the digital video include four Y components and two UV components, and the encoding framework may separately encode the Y component (that is, luma block) and the UV component (that is, chroma block). Similarly, the decoding side may perform decoding according to a format.

For an intra prediction process, the to-be-encoded image block may be predicted by using an angular prediction mode and a non-angular prediction mode, so as to obtain the prediction block. According to rate-distortion information calculated based on the prediction block and the to-be-encoded image block, an optimal prediction mode of the to-be-encoded image block is selected, and the prediction mode is transmitted to the decoding side through the bitstream. The decoding side obtains the prediction mode by parsing, obtains the prediction block of the target decoding block by prediction, and adds the prediction block and the time domain residual block obtained from the bitstream, to obtain the reconstructed block.

With the development of digital video coding standards, the non-angular prediction mode is relatively stable, including an average mode and a planar mode. A quantity of the angular prediction mode increases with evolution of the digital video coding standard. Taking the international digital video encoding standard H series as an example. H. 264/AVC standard includes only 8 angular prediction modes and 1 non-angular prediction mode. H.265/HEVC includes 33 angular prediction modes and 2 non-angular prediction modes. In H. 266/VVC, the intra prediction mode is further extended, and the intra prediction mode includes 67 conventional prediction modes and a non-conventional prediction mode: matrix weighted intra-frame prediction (MIP) mode, for a luma block. The 67 conventional prediction modes include a planar mode, a DC mode, and 65 angular prediction modes. The planar mode is usually used to process a block with changing textures, the DC mode is usually used to a flat region, and the angular prediction mode is usually used to process a block with an obvious angle texture.

It should be noted that in this application, the current block used for intra prediction may be a square block, or may be a rectangle block.

Further, since an intra prediction block is square, usage probabilities for all the angular prediction modes are equal to each other. When a length and a width of the current block are not equal, a usage probability of an upper reference pixel is greater than a usage probability of a left reference pixel for a horizontal block (whose width is greater than height), and a usage probability of an upper reference pixel is less than a usage probability of a left reference pixel for a vertical block (whose height is greater than width). When predicting the rectangle block, the traditional angular prediction mode is converted to a wide angular prediction mode. When the rectangle block is predicted by using the wide angular prediction mode, a prediction angle range of the current block is greater than a prediction angle range when the rectangle block is predicted by using the traditional angular prediction mode. Optionally, when the width angular prediction mode is used, a signal may be transmitted by using an index of the conventional angular prediction mode. Correspondingly, after receiving the signal, the decoding side may convert the conventional angular prediction mode to the width angular prediction mode. Therefore, both a total quantity of intra prediction modes and an encoding method of the intra prediction mode may remain unchanged.

Further, a to-be-executed intra prediction mode may be determined or selected based on a size of the current block. For example, the width angular prediction mode may be determined or selected based on the size of the current block to perform intra prediction on the current block. For example, when current block is a rectangle block (the width and height are different), the width angular prediction mode may be used to perform intra prediction the current block. An aspect ratio of the current block may be used to determine an angular prediction mode replacing the width angular prediction mode and a replaced angular prediction mode. For example, when predicting the current block, any intra prediction mode with an angle not exceeding a diagonal (from a lower left corner to an upper right corner of the current block) of the current block may be selected as the replaced angular prediction mode.

FIG. 2 is a schematic block diagram of a decoding framework 200 according to an embodiment of this application.

As shown in FIG. 2, the decoding framework 200 may include an entropy decoding unit 210, an inverse transform and inverse quantization unit 220, a residual unit 230, an intra prediction unit 240, an inter prediction unit 250, an in-loop filtering unit 260, and a decoded image buffering unit 270. After receiving a bitstream, the entropy decoding unit 210 parses the bitstream to obtain a prediction block and a frequency domain residual block. The inverse conversion and inverse quantization unit 220 performs operations such as inverse conversion and inverse quantization on the frequency domain residual block to obtain a time domain residual block. The residual unit 230 superposes a prediction block predicted by the intra prediction unit 240 or the inter prediction unit 250 and the time domain residual block, to obtain a reconstructed block.

It should be noted that the decoding method and the encoding method provided in embodiments of this application affect the intra prediction part in the video encoding hybrid framework, and are specifically applied to the IntraTMP part of the intra prediction. The decoding method provided embodiments of this application is applied to the intra prediction part of the decoding side, and the encoding method provided in embodiments of this application is applied to the intra prediction part of the encoding side.

To facilitate understanding of the technical solutions of this application, the following describes related content.

(1) Intra Template Matching Prediction (IntraTMP) mode.

The IntraTMP mode is a special luma block intra prediction encoding mode, which is mainly applied to the screen content encoding.

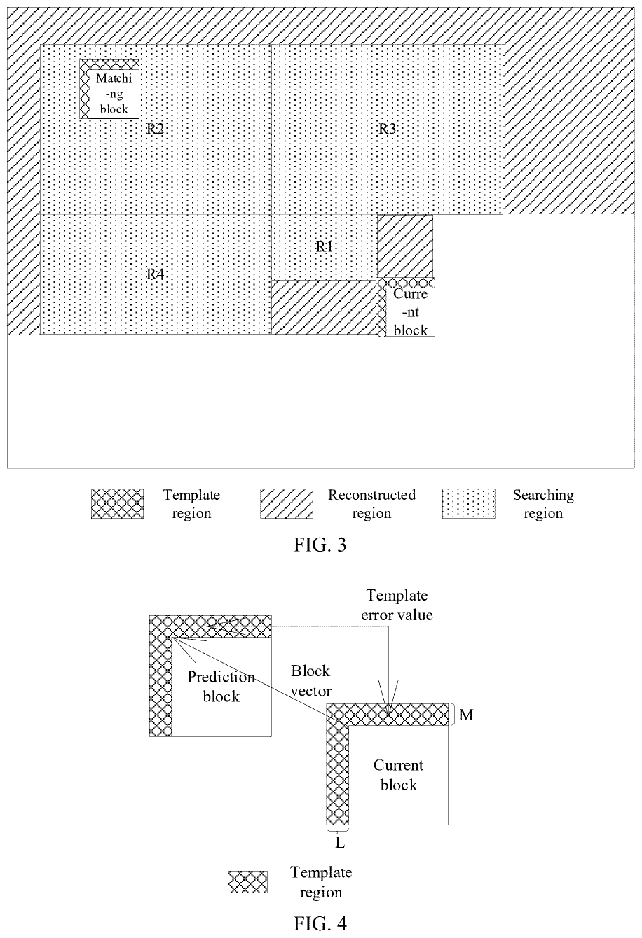

FIG. 3 is a schematic diagram of an IntraTMP mode according to an embodiment of this application.

As shown in FIG. 3, the IntraTMP mode is mainly implemented by the following processes.

The encoder (or decoder) selects an L-shaped of reconstructed pixels adjacent to a current encoding block as a template, searches a given reconstructed region of the current frame for a most similar template, and uses a reconstructed block corresponding to the most similar template as a matching block, to serve as a prediction block of the current encoding block. For example, R1 to R4 in FIG. 3 are available search areas in the IntraTMP mode. For example, a matching block may be searched for in a raster scan sequence point by point in R1 to R4.

FIG. 4 shows an example of a template error difference between a current block and a matching block according to an embodiment of this application.

As shown in FIG. 4, a template of the current block may include L columns of pixels on a left side of the current block, M columns of pixels on an upper side of the current block, and M rows and L columns of pixels at an upper left corner of the current block, where both M and L are positive integers. For example, values of both M and Lare 4. A matching block of the current block may be represented by a block vector from the current block to the matching block. A similarity between the template of the current block and the template of the matching block is represented by a size of a template error value. A smaller template error value indicates a higher similarity. For example, a template error value may be calculated by using sum of absolute difference (SAD). A smaller SAD indicates a higher similarity of templates.

The encoder indicates whether the current coding block uses the IntraTMP mode by using a flag bit cu_tmp_flag. If yes, the same template matching process is performed at the decoding side to obtain the same prediction block at the decoding side. For the IntraTMP mode, no additional encoding block vector information is required in the bitstream.

(2) IntraTMP adaption for camera-captured content technology.

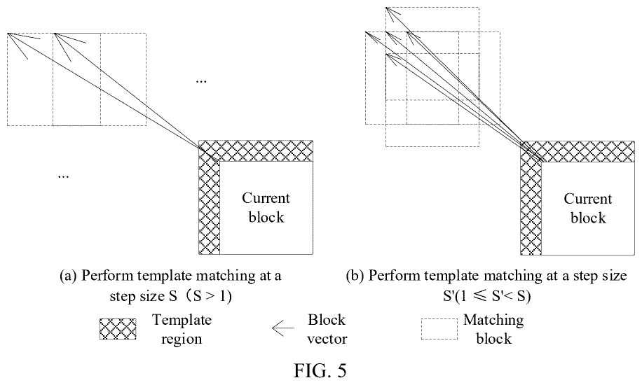

FIG. 5 shows an example of an IntraTMP adaptation for camera-captured content according to an embodiment of this application.

As shown in (a) in FIG. 5, based on the original IntraTMP mode, the IntraTMP adaptation for camera-captured content proposes to perform template matching by using a step S (that is, every S points in horizontal or vertical direction, S>1). For example, in a search area, a matching block is not searched for point by point by raster scan (raster scan), but is searched for every S points in a horizontal or vertical direction in the search area. For example, if a block vector on which template matching is currently performed is (X₀, Y₀), a next block vector in the horizontal direction on which template matching is to be performed should be (X₀+S, Y₀), and a vertical coordinate of a next block vector in the vertical direction on which template matching is to be performed should be Y₀+S. As shown in (b) in FIG. 5, after template matching is completed, an optimal matching block is refined within a range (that is, template matching is performed at a smaller step S′). For example, the matched block vector is refined by using the method of performing template matching at a smaller step, to optimize a matching result. This technology effectively reduces complexity of the IntraTMP mode while maintaining relative good encoding efficiency.

(3) template-based intra mode derivation (TIMD) technology.

The TIMD technology uses L-shaped of reconstructed pixels adjacent to a current encoding block as a template. Specifically, the encoding side may calculate prediction pixels of a template area in different intra prediction modes by traversing a Most Probable Mode (Most Probable Mode, MPM) list. Further, a template error difference between predicted pixels and reconstructed pixels in different intra prediction modes is obtained. For example, the template error value may be represented by a sum of absolute transformed difference (SATD). Therefore, the encoding side may select the optimal intra prediction mode according to the template error value. In the decoding side, the intra prediction mode is obtained by using a same derivation manner, thereby reducing encoding bits of mode information.

(4) combined inter and intra prediction (CIIP) mode.

The CIIP mode combines the intra prediction and the inter prediction, and obtains the prediction block of the current encoding block by using a weighted combination of the intra prediction block and the inter prediction block. In enhanced compression model (ECM), a CIIP mode is combined with a template-based prediction technology, and different weights are set for different regions, thereby further improving prediction accuracy. Specifically, the intra prediction block pred_intra is obtained by using the TIMD mode, and the inter prediction block pred_inter is obtained by using a Merge (Merge) mode based on a template. The encoding side determines weight values wIntra and wInter according to the derived intra prediction mode and a position of a to-be-predicted pixel. The final prediction block Pred is calculated as follows:

$$Pred = ( wIntra * pred\_intra + wInter * pred\_inter + 4 ) >> 3$$

In which, Pred represents a prediction block of the current block, pred_intra represents an intra prediction block, wIntra represents a weight value of the intra prediction block, wInter represents an inter prediction block, and pred_inter represents a weight value of the inter prediction block.

The wIntra and the wInter may be determined according to the intra prediction mode intra_dir derived by using the TIMD. ECM includes 65 intra-frame angular prediction modes (2≤intra_dir<=66). When 2≤intra_dir<34, the current coding block is divided vertically into four equal regions. When 34<=intra_dir<=66, the current coding block is divided horizontally into four equal regions. For example, the weight values wIntra and wInter of each region may be determined with reference to Table 1:

TABLE 1

| region index | (wIntra, wInter) |
|---|---|
| 0 | (6, 2) |
| 1 | (5, 3) |
| 2 | (3, 5) |
| 3 | (2, 6) |

As shown in Table 1, different region indexes correspond to different wIntra and different wInter. Specifically, when the region flag is 0, wIntra is 6 and wInter is 2; when the region flag is 1, wIntra is 5 and wInter is 3; when the region flag is 2, wIntra is 3 and wInter is 5; and when the region flag is 3, wIntra is 2 and wInter is 6.

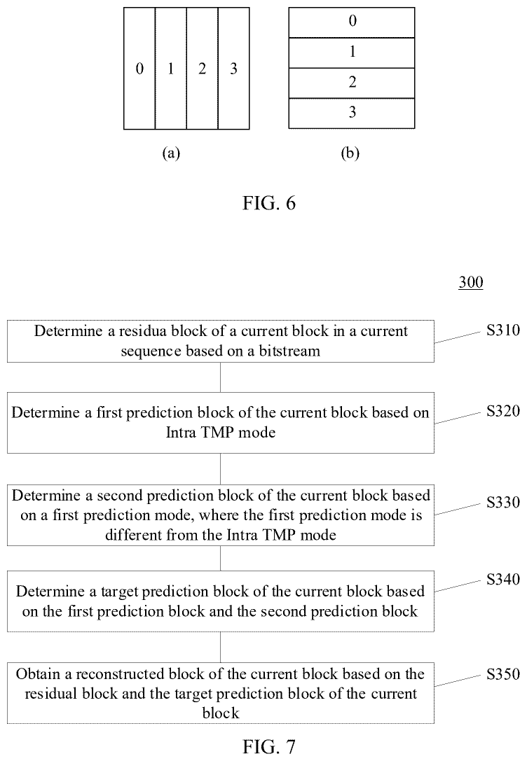

FIG. 6 is a schematic diagram of a region division method of a current block according to an embodiment of this application.

As shown in (a) of FIG. 6, when the current coding block is divided vertically into four equal regions, the region indexes are respectively 0, 1, 2, and 3 in an order from left to right. As shown in (b) of FIG. 6, when the current coding block is divided horizontally into four equal regions, the region indexes are respectively 0, 1, 2, and 3 in an order from top to bottom.

It should be noted that when intra_dir is equal to 0 or 1, wIntra and wInter may be determined in another manner. For example, when intra_dir is equal to 0 or 1, the current coding block is not divided into sub-regions, and wIntra and wInter are selected from (3,1), (2,2), and (1,3) according to encoding types (intra-frame or inter-frame) of two encoding blocks located on a left side and an upper side. For example, if encoding types of the two encoding blocks are intra-frame encoding, the encoding side determines (wIntra, wInter) as (3,1). If an encoding type of one of the two encoding blocks is intra-frame encoding and an encoding type of the other encoding block is inter-frame encoding, the encoding side determines (wIntra, wInter) as (2,2). If encoding types of the two encoding blocks are inter-frame encoding, the encoding side determines (wIntra, wInter) as (3,1).

It should be noted that, based on the IntraTMP mode described above, in the IntraTMP mode, an optimal matching block is selected as the prediction block by using the template. However, in this method, due to noise generated in a lossy compression process and a limited correlation between the template and the corresponding block, a prediction error is generated. In some cases, an accurate prediction block cannot be obtained, resulting in reducing of decoding performance of the decoder. In addition, in the IntraTMP mode, prediction is performed by block compensation. In a scenario in which there are many repeated pixel blocks in a screen content sequence, even if the decoder selects, by using the template, an optimal matching block based on the IntraTMP mode as the prediction block, decoding performance of the decoder can be ensured. However, in a scenario in which there are many noise signals and pixel change is complicated in a natural content sequence, if the decoder still selects, by using a template, an optimal matching block based on the IntraTMP mode as a prediction block, the IntraTMP mode may reduce the decoding performance of the decoder when a difference between the current block and the optimal matching block selected by using the template based on the IntraTMP mode is relatively large. In view of this, embodiments of this application provide a decoding method, an encoding method, a decoder, and an encoder, so as to improve the coding performance. In this solution, a combined fusion prediction technology based on intra template matching prediction (IntraTMP) is proposed. A matching block is obtained based on intra-frame template matching, and then the matching block is fused with an intra prediction block to generate a prediction block of the current encoding block. Specifically, the decoder obtains a matching block of the current encoding block by using intra-frame template matching as a prediction block 1; obtains a prediction block 2 of the current encoding block by using an intra prediction mode other than the IntraTMP; determines weight values for predictions block 1 and 2; performs weighting fusion on the prediction blocks by using the weight values of the prediction blocks to obtain a final prediction block, thereby implementing IntraTMP combined fusion prediction.

FIG. 7 is a schematic flowchart of a decoding method 300 according to an embodiment of this application. It should be understood that the decoding method 300 may be executed by a decoder or a decoding framework. For example, the decoding method may be applied to the decoding framework shown in FIG. 2. For ease of description, the following describe the decoding method 300 by taking the decoder as an example.

As shown in FIG. 7, the decoding method 300 may include the following steps S310 to S350.

In step S310, a residual block of a current block in a current sequence is determined based on a bitstream.

For example, the decoder determines the residual block of the current block by decoding the bitstream, where the bitstream decoded by the decoder is the bitstream of the current sequence.

In step S320, a first prediction block of the current block is determined based on an Intra Template Matching Prediction (Intra Template Matching Prediction, IntraTMP) mode.

In step S330, a second prediction block of the current block is determined based on the first prediction mode. The first prediction mode is different from the IntraTMP mode.

For example, the first prediction mode is an intra prediction mode.

For example, the first prediction mode is an inter prediction mode.

For example, the first prediction mode is angular prediction mode.

For example, the first prediction mode is a non-angular prediction mode.

In S340, a target prediction block of the current block is determined based on the first prediction block and the second prediction block.

For example, the decoder may fuse the first prediction block with the second prediction block to obtain the target prediction block.

In S350, a reconstructed block of the current block is obtained based on the residual block and the target prediction block of the current block.

In embodiments of this application, the decoder determines a first prediction block based on the IntraTMP mode, determines a second prediction block based on the first prediction mode, and further determines a target prediction block of the current block based on the first prediction block and the second prediction block. That is, the decoder may determine the target prediction block based on the IntraTMP mode and the first prediction mode. Compared with a solution in which the optimal matching block obtained based on the IntraTMP mode is directly used as the target prediction block, the decoder corrects the first prediction block based on the second prediction block according to the technical solution of this application, thereby improving accuracy of the target prediction block, and improving the decoding performance.

With reference to Table 2, the following describes a result obtained after performing testing on a test sequence required by the JVET in All Intra condition, on ECM6.0 integrating the IntraTMP adaptation for camera-captured content technology according to the solution of this application. End-to-end attribute rate distortion (End-to-End Bit distortion, End-to-End BD-rate) is an indicator for evaluating algorithm performance or encoding performance, and indicates a change of a bit rate and a PSNR of an encoding algorithm provided in this application relative to an original encoding algorithm. A negative value of the End-to-End bit distortion indicates that the performance is improved. Y, U, and V represent components of the current block.

TABLE 2

| | | | | encoding | decoding |
|---|---|---|---|---|---|
| | | | | performance | performance |
| | Y (BD- | U (BD- | V (BD- | improvement | improvement |
| | rate) | rate) | rate) | (EncT) | (DecT) |
| Category | 0.01% | −0.05% | −0.08% | 102% | 101% |
| A1 | | | | | |
| Category | −0.01% | −0.03% | −0.10% | 102% | 102% |
| A2 | | | | | |
| Category | −0.03% | −0.16% | −0.10% | 101% | 102% |
| B | | | | | |
| Category | −0.04% | 0.06% | −0.09% | 102% | 103% |
| C | | | | | |
| Category | −0.10% | 0.03% | −0.13% | 102% | 101% |
| E | | | | | |
| Average | −0.04% | −0.04% | −0.10% | 102% | 102% |
| Category | 0.00% | 0.03% | 0.05% | 101% | 99% |
| D | | | | | |
| Category | 0.07% | 0.16% | −0.04% | 101% | 101% |
| F | | | | | |

As shown in Table 2, it can be learned from a test result that, the performance of all sequence categories is improved according to the solution of this application, and BD-rate change average values for Y, U, and V components are respectively −0.04%, −0.04%, and −0.10%. It indicates that the encoding performance is improved with relatively low complexity. In addition, a decoding time consumed by the decoding method provided in this embodiment increases by only 2%, and an encoding method consumed by the encoding method corresponding to the decoding method increases by only 2%.

In some embodiments, S320 may include:
determining a first flag based on the bitstream; and
if the first flag indicates to perform fusion prediction by using the IntraTMP mode, determining the first prediction block based on the IntraTMP mode.

For example, the decoder decodes the bitstream to obtain the first flag. If the first flag indicates to perform fusion prediction by using the Intra TMP mode, the decoder predicts the first prediction block based on the IntraTMP mode. Otherwise, the decoder obtains the target prediction block by using another prediction mode.

For example, the first flag may be a sequence-level flag, may be an image-level (that is, a frame-level) flag, may be a slice-level flag, or may be an image block-level flag.

For example, when the value of the first flag is 0, it indicates that the Intra TMP mode is used for fusion prediction; and when the value of the first flag is 1, it indicates that the IntraTMP mode is not used for fusion prediction. Alternatively, when the value of the first flag is 1, it indicates that the IntraTMP mode is used for fusion prediction; and when the value of the first flag is 0, it indicates that the IntraTMP mode is not used for fusion prediction. Certainly, whether to use the IntraTMP mode may be indicated by using another value of the first flag, which is not limited in embodiments of this application.

Certainly, the first flag may implement a corresponding indication function in another manner, which is not limited in this application.

For example, when the value of the first flag is “true”, it indicates that the IntraTMP mode is used for fusion prediction; and when the value of the first flag is “false”, it indicates that the IntraTMP mode is not used for fusion prediction.

For example, if the first flag indicates that the IntraTMP mode is not used to perform fusion prediction, the decoder may determine a prediction mode of the current block by decoding the bitstream. In other words, if the first flag indicates that the IntraTMP mode is not used to perform fusion prediction, the decoder is unnecessary to predict the first prediction block based on the IntraTMP mode, and is unnecessary to determine the target prediction block based on the first prediction block and the second prediction block.

In some embodiments, the decoder determines a second flag based on the bitstream. If the second flag indicates to perform prediction by using the IntraTMP mode, the decoder determines the first flag based on the bitstream.

Schematically, the decoder decodes the bitstream to obtain the second flag. If the second flag indicates to perform prediction by using the IntraTMP mode, the decoder decodes the bitstream to obtain the first flag. Otherwise, the decoder obtains the target prediction block by using another prediction mode.

For example, the second flag may be a sequence-level flag, may be an image-level (that is, a frame-level) flag, or may be a slice-level flag, or may be an image block-level flag.

For example, when the value of the second flag is 0, it indicates that the IntraTMP mode is used for prediction; and when the value of the second flag is 1, it indicates that the IntraTMP mode is not used for prediction. Alternatively, when the value of the second flag is 1, it indicates that the IntraTMP mode is used for prediction; and when the value of the second flag is 0, it indicates that the IntraTMP mode is not used for prediction. Certainly, whether to use the IntraTMP mode may also be indicated by using another value of the second flag, which is not limited in embodiments of this application.

Certainly, the second flag may also implement a corresponding indication function in another manner, which is not limited in this application.

For example, when the value of the second flag is “true”, it indicates that the IntraTMP mode is used for prediction; and when the value of the second flag is “false”, it indicates that the IntraTMP mode is not used for prediction.

Schematically, if the second flag indicates that the IntraTMP mode is not used for prediction, the decoder may determine a prediction mode of the current block by decoding the bitstream. In other words, if the second flag indicates that the IntraTMP mode is not used for fusion prediction, the decoder is unnecessary to predict the first prediction block based on the IntraTMP mode, and is unnecessary to determine the target prediction block based on the first prediction block and the second prediction block.

Schematically, if the second flag indicates that the IntraTMP mode is used for prediction, and the first flag indicates that the IntraTMP mode is not used for fusion prediction, the decoder predicts an optimal matching block based on the IntraTMP mode, and determines the target prediction block based on the optimal matching block. For example, the decoder may directly determine the optimal matching block as the target prediction block.

Schematically, when the decoder reads the bitstream, syntax elements indicating performing fusion prediction by using the IntraTMP may be implemented as shown in Table 3.

TABLE 3

| | |
|---|---|
| coding_unit( x0, y0, cbWidth, cbHeight, cqtDepth, | |
| treeType, modeType ) { | |
| ... | |
| if( CuPredMode[ chType ][ x0 ][ y0 ] = = MODE_INTRA \|\| | |
| CuPredMode[ chType ][ x0 ][ y0 ] = = MODE_PLT ) { | |
| if( treeType = = SINGLE_TREE \|\| treeType = = | |
| DUAL_TREE_LUMA ) { | |
| if( pred_mode_plt_flag ) | ae(v) |
| ... | |
| else { | |
| if( sps_bdpcm_enabled_flag && cbWidth <= | |
| MaxTsSize && cbHeight <= MaxTsSize ) | |
| intra_bdpcm_luma_flag | ae(v) |
| if( intra_bdpcm_luma_flag ) | |
| ... | |
| else { | |
| If( sps_tmp_enabled_flag && | |
| cbWidth <= MaxTmpSize && cbHeight <= | |
| MaxTmpSize ) | |
| intra_tmp_flag | ae(v) |
| if( Intra_tmp_flag ) | |
| intra_tmp_ciip_flag | ae(v) |
| else { | |
| ... | |
| } | |
| } | |
| } | |
| } | |
| ... | |
| } | |
| ... | |
| } | |

Explanations of the elements in Table 3 are as follows:
coding_unit: encoding block-related syntax element;
pred_mode_plt_flag: block flag bit, indicating whether the current encoding block is encoded by using the PLT mode.
intra_bdpcm luma_flag: block flag bit, indicating whether a luma component of the current encoding block is encoded by using the BDPCM mode.
sps_tmp_enabled_flag: SPS flag bit, indicating whether a video sequence may be predicted by using the IntraTMP mode. If a value of the flag is 1, the current video sequence may be predicted by using the Intra TMP mode. If the value of the flag is 0, the current video sequence cannot be predicted by using the IntraTMP mode. The value of the SPS flag bit may be set by a user.

MaxTmpSize: SPS parameter, indicating a limitation of a size of the block that may be predicted by using the IntraTMP mode. If a width or a height of the block is greater than MaxTmpSize, the IntraTMP mode cannot be used for prediction. SPS parameters may be set by the user.
intra_tmp_flag (that is, the second flag described above): block flag bit, indicating whether the IntraTMP mode is used for prediction of the current block. If a value of intra_tmp_flag is equal to 1, the IntraTMP mode is used for prediction of the current block, and the decoder needs to decode the flag bit intra_tmp_ciip_flag. If the value of intra_tmp_flag is equal to 0, the IntraTMP mode is not used for prediction of the current block, and the decoder needs to decode the flag bit intra_tmp_ciip_flag.

Intra_tmp_ciip_flag (that is, the first flag described above): block flag bit, indicating whether IntraTMP is used to perform fusion prediction on the current encoding block. If a value of intra_tmp_ciip_flag is equal to 1, the IntraTMP is used to perform fusion prediction on the current block. If the value of intra_tmp_ciip_flag is equal to 0, original IntraTMP is used for prediction of the current block.

In some embodiments, the decoder may determine the first flag in the following manner:
determining a target context index; and
determining the first flag by using the target context index based on the bitstream.

Schematically, the target context index is used for identifying only a context or a context model, so that after determining the target context index, the decoder may decode the bitstream by using a context or context model indicated by the target context index, to obtain the first flag.

Certainly, in another alternative embodiments, the decoder may also determine the context index used by the second flag. A method for determining the context index used by the second flag may be the same as or different from the method for determining the context index used by the first flag. This is not specifically limited in this application.

In some embodiments, the decoder determines the target context index based on decoding information of an adjacent decoding block of the current block, and/or the decoder determines the target context index based on a size of the current block.

Schematically, the decoding information of the adjacent decoding block includes but is not limited to information such as a prediction mode used by the adjacent decoding block, a context index used when a block-level flag of the adjacent decoding block is decoded, a template of the adjacent decoding block, a location of the adjacent decoding block, and a decoded value of the adjacent decoding block.

Schematically, a size of the current block includes but is not limited to information such as a height of the current block, a width of the current block, and a quantity of pixels in the current block.

Schematically, the decoder decodes the first flag by using the target context index CtxIdxInc, where the target context index may be determined according to information such as decoding information of an adjacent decoding block and a size of the current block. For example, the target context index determined by the decoder based on the decoding information of the adjacent decoding block may have Q values, for example, Q is equal to 3 or another value.

In some embodiments, coordinates of the current block are (x, y), and the adjacent decoding block includes a first decoding block whose coordinates are (x−1, y) and a second decoding block whose coordinates are (x, y−1). Decoding information of the first decoding block includes a prediction mode used by the first decoding block, and decoding information of the second decoding block includes a prediction mode used by the second decoding block. In this case, the decoder may determine the target context index in the following manner: if a prediction mode used by the first decoding block is a mode in which fusion prediction is performed based on the IntraTMP mode, assigning A to a first value, otherwise, assigning B to the first value, where both A and B are integers; if the prediction mode used by the second decoding block is a prediction mode in which fusion prediction is performed based on the IntraTMP mode, assigning C to a second value, otherwise, assigning D to the second value, where both C and D are integers; and determining a sum of the first value and the second value as the target context index.

For example, A=1, B=0, C=1, and D=0. That is, it is assumed that coordinates of the current block are (x, y); if a decoding block cuLeft exists at coordinates (x−1, y) and intra_tmp_ciip_flag of cuLeft is 1, CtxIdxInc is 1; otherwise, CtxIdxInc is 0. If a decoding block cuAbove exists at coordinates (x, y−1) and intra_tmp_ciip_flag of cuAbove is 1, CtxIdxInc is increased by 1, otherwise, CtxIdxInc is increased by 0.

Certainly, in another alternative embodiments, A, B, C, and D may be other values, which is not specifically limited in this application.

In some embodiments, S320 may include:
performing template matching on the current block based on the IntraTMP mode to obtain an optimal matching block; and
determining the first prediction block based on the optimal matching block.

Schematically, the decoder may determine, by intra-frame template matching, a reconstructed block whose template matches a matching block of the current block in different locations in a search area of the current block, as a matching block of the current block. For example, the decoder may determine a reconstruction block whose template is the same as the template of the current block in different locations in the search area of the current block, as the matching block of the current block. After completing the template matching process, the decoder ranks all matching blocks of the current block in an ascending order of template error values, and determines the matching block ranked first among all the matching blocks as the optimal matching block.

In some embodiments, the decoder determines the optimal matching block as the first prediction block.

Schematically, after completing the template matching process, the decoder ranks all matching blocks of the current block in an ascending order of template error values, and determines a matching block ranked first among all the matching blocks as the first prediction block.

In some embodiments, the decoder refines the optimal matching block to obtain the first prediction block.

Schematically, when the decoder performs refinement on the optimal matching block, the decoder may determine, by using intra-frame template matching, a reconstructed block whose template matches the template of the current block and whose template error value is smallest, in different locations in a refinement range of the optimal matching block, as a matching block obtained by refining the optimal matching block. For example, the decoder may determine a reconstructed block whose template is the same as the template of the current block and whose template error value is smallest in different locations in the refining range of the optimal matching block, as the matching block obtained by refining the optimal matching block.

In some embodiments, the decoder may refine the optimal matching block in the following manner to obtain the first prediction block:
determining a refinement range of the optimal matching block; performing intra-frame template matching in the refining range based on at least one matching step size, to obtain a matching block in the refining range, where each matching step size in the at least one matching step size is less than a matching step size used by the optimal matching block; and determining a matching block with a minimum template error value among the matching block in the refinement range as a matching block obtained by refining the optimal matching block; and determining the matching block obtained by refining the optimal matching block as the first prediction block.

Schematically, when the at least one matching step size includes one matching step size, the decoder determines a matching block with a minimum template error value among the matching block in the refining range as a matching block obtained by refining the optimal matching block, and determines the matching block obtained by refining the optimal matching block as the first prediction block.

Schematically, when the at least one matching step size includes multiple different matching step sizes, the decoder may determine, by traversing the multiple matching step sizes in a descending order, the i-th matching step size of the multiple matching step sizes; and determines, based on the i-th matching step size, a matching block with a minimum template error value among the matching block in the refinement range, as a matching block obtained by performing refinement based on the i-th matching step size. Then, the decoder refines, based on the (i+1)-th matching step size, the matching block obtained by performing refinement based on the i-th matching step size, until the decoder refines, based on the last matching step size, a matching block obtained by performing refinement based on the penultimate matching step size, and determines, as the first prediction block, a matching block obtained by performing refinement based on the last matching step size. It should be noted that when the decoder refines, based on the (i+1)-th matching step size, the matching block obtained by performing refinement based on the i-th matching step size, the refinement range may be a refinement range of the optimal matching block, or may be a refinement range of the matching block obtained by performing refinement based on the i-th matching step size. This is not specifically limited in this application.

In some embodiments, the process of determining a refinement range of the optimal matching block includes:
determining the refinement range based on the size of the current block and the optimal matching block.

For example, the decoder may determine, by using the block vector of the optimal matching block as a center of the refining range, the size of the refinement range based on the size of the current block and the matching step size of the optimal matching block.

In some embodiments, the decoder determines (S/F)*H as the refinement range by taking a block vector from a current block to the optimal matching block as a center. In which, / represents a division operator, * represents a multiplication operator, S represents a matching step size used by the optimal matching block, H represents a height of the current block, and F is a positive integer.

Schematically, the decoder determines a rectangle whose side length is (S/E)*H as the refinement range by taking the block vector from the current block to the optimal matching block as a center. Alternatively, the decoder determines a circle whose radius is (S/E)*H as the refinement range by using the block vector from the current block to the optimal matching block as the center.

Certainly, in another alternative embodiments, the refinement range may also have another shape or a shape of another size, which is not specifically limited in this application.

In some embodiments, the decoder determines the refinement range based on a predefined value.

For example, the predefined value may include a size of the refinement range.

For example, the decoder determines a rectangle whose side length is the predefined value as the refinement range, by taking the block vector from the current block to the optimal matching block as the center. Alternatively, the decoder determines, as the refinement range, a circle whose radius is the predefined value by taking the block vector from the current block to the optima matching block as the center.

Certainly, in another alternative embodiments, the refinement range may also have another shape or a shape of another size, which is not specifically limited in this application.

For example, the predefined value may be a default value. For example, the predefined value may be implemented by pre-storing a corresponding code, table, or another manner indicating related information in a device (for example, including the decoder), which is not limited in this application. For example, the predefined value may refer to a value defined in a protocol. It should be further understood that, in embodiments of this application, the “protocol” may refer to a standard protocol in the coding field, for example, including an image coding field, a video coding field, a hardware video coding field, a dedicated circuit video coding field, a real-time video coding field, and a related protocol applied to a future coding system. This is not limited in this application.

In some embodiments, S320 may include:
performing template matching on the current block based on the IntraTMP mode to obtain multiple matching blocks; and
performing weighting processing on the multiple matching blocks to obtain the first prediction block.

Schematically, the decoder may determine, by intra-frame template matching, a reconstructed block whose template matches a template of the current block in different locations in a search area of the current block, as a matching block of the current block. For example, the decoder may determine a reconstructed block whose template is the same as the template of the current block in different locations in the search area of the current block, as the matching block of the current block. After completing the template matching process, the decoder ranks all matching blocks of the current block in an ascending order of template error differences, selects multiple matching blocks ranked front in a ranking order, and performs weighting processing on the selected multiple matching blocks to obtain the first prediction block.

Schematically, weight values of the multiple matching blocks may be equal, may be partially equal, or may be different from each other.

Schematically, when the multiple matching blocks have the same weights, the first prediction block is an average of the multiple matching blocks.

Schematically, the decoder determines a weight value of each matching block based on the template error value of the matching block, a quantity of the multiple matching blocks, and a sum of weights of the multiple matching blocks.

Schematically, the weight value of the matching block is negatively correlated with the template error value of the matching block.

Schematically, the weight value of the matching block is negatively correlated with the quantity of the multiple matching blocks.

Schematically, the weight value of the matching block is positively correlated with the sum of weights of the multiple matching blocks.

Certainly, in another alternative embodiments, the decoder may determine the weight value of the matching block by using only the template error value or other information, which is not specifically limited in this application.

For example, the decoder selects, based on the quantity of the multiple matching blocks, a first candidate set that includes a weight value equal to the quantity of the multiple matching blocks from multiple candidate sets. Then, the decoder determines the weight value of the matching block based on the first candidate set.

For example, different candidate sets in the multiple candidate sets include different quantities of weight values.

In some embodiments, the template error value of the matching block is negatively correlated with the weight value of the matching block.

For example, the weight value of the matching block may be any predefined fixed value, and different weight values are assigned to different matching blocks according to a quantity of the multiple matching blocks, the template error values of the matching blocks, and the like. For example, a weight value is set to {3/4, 1/4}, {1/2, 1/4, 1/4}. If there are two matching blocks pred₁, pred₂ and corresponding template error values satisfy SAD₁≤SAD₂, a weight value W₁ of pred₁ is equal to 3/4 and a weight value W₂ of pred₂ is equal to 1/4. If there are three matching blocks pred1, pred2 and pred3 and corresponding template error values satisfy SAD₁≤SAD₂≤SAD₃, the weight values of pred1, pred2, and pred3 are respectively 1/2, 1/4 and 1/4.

In some embodiments, step S340 may include:
determining a weight value of the first prediction block and a weight value of the second prediction block; and
performing weighting processing on the first prediction block and the second prediction block by using the weight value of the first prediction block and the weight value of the second prediction block, to obtain the target prediction block.

Schematically, the decoder determines a weight value of the first prediction block and a weight value of the second prediction block, multiplies the weight value of the first prediction block by the first prediction block to obtain a first intermediate block, multiplies the weight value of the second prediction block by the second prediction block to obtain a second intermediate block, and then combines the first intermediate block and the second intermediate block to obtain a fusion block. Then, the decoder may determine the target prediction block based on the fusion block. For example, the decoder may directly determine the fusion block as the target prediction block, or may process the fusion block to obtain the target prediction block.

In some embodiments, the decoder determines the weight value of the first prediction block and the weight value of the second prediction block based on at least one of the following:
encoding information of an adjacent encoding block, a size of the current block, a template size of the current block, a type of the first prediction mode, and a location of each region of the current block.

For example, the decoder may determine a weight value of the first prediction block (or a weight value of the second prediction block) based on at least one of: decoding information of an adjacent decoding block, a size of the current block, a template size of the current block, a type of the first prediction mode, or a location of each region of the current block, and then determine a weight value of the second prediction block (or a weight value of the first prediction block) based on a predefined total weight value and the weight value of the first prediction block (or a weight value of the second prediction block). For example, the decoder may determine a weight value corresponding to at least one of decoding information of an adjacent decoding block, a size of the current block, a template size of the current block, a type of the first prediction mode, or a location of each region of the current block, as the weight value of the first prediction block (or the weight value of the second prediction block). The weight value of the second prediction block (or the weight value of the first prediction block) is a difference between the total weight value and the weight value of the first prediction block (or the weight value of the second prediction block).

Certainly, the weight value of the first prediction block and the weight value of the second prediction block may also be determined in another manner. The determination manner is not limited in this application. For example, the weight value of the first prediction block and the weight value of the second prediction block may be determined by decoding the bitstream. In another example, the weight value of the first prediction block may be determined based on the template error difference of the first prediction block, and then the weight value of the second prediction block is determined based on a predefined total weight value and the weight value of the first prediction block. For example, the weight value of the first prediction block is negatively correlated with the template error difference of the single matching block, and the weight value of the second prediction block is a difference between the total weight value and the weight value of the first prediction block.

In some embodiments, both the weight value of the first prediction block and the weight value of the second prediction block are predefined weight values.

For example, a ratio of the weight value of the first prediction block to the weight value of the second prediction block, and a sum of the weight value of the first prediction block and the weight value of the second prediction block are both predefined values.

For example, the predefined weight value may be a default weight value. For example, the predefined weight value may be implemented by pre-storing a corresponding code, table, or another manner indicating related information in a device (for example, including the decoder). A specific implementation manner of the predefined weight value is not limited in this application. For example, the predefined weight value may refer to a weight value defined in a protocol. It should be further understood that, in embodiments of this application, the “protocol” may refer to a standard protocol in the decoding field, for example, including an image coding field, a video coding field, a hardware video coding field, a dedicated circuit video coding field, a real-time video coding field, and a related protocol applied to a future coding system. This is not limited in this application.

In some embodiments, the decoder adds C_{offset} to a value obtained by performing weighting processing on the first prediction block and the second prediction block to obtain a result, and performs right shift C_{Shift} on the result to obtain the target prediction block. In which, C_{offset} is a value determined according to C_{Shift}, and C_{Shift} is a value determined according to a sum of the weight value of the first prediction block and the weight value of the second prediction block.

For example, the decoder may determine the target prediction block by using the following formula:

$$Pred = {W}_{1} * {pred}_{1} + {W}_{2} * {pred}_{2} + {C}_{offset} ) >> {C}_{Shift} ;$$

in which, Pred represents the target prediction block, pred₁ represents the first prediction block, W₁ represents a weight value of the first prediction block, pred₂ represents the second prediction block, and W₂ represents a weight value of the second prediction block.

In some embodiments, C_{offset}=1<<(CShift−1), C_{Shift}=┌logWsum┐; ┌┐ is a ceiling operator, << is a left-shifted operator, and Wₛᵤₘ represents a sum of the weight value of the first prediction block and the weight value of the second prediction block.

For example, C_{offset}=1<<(C_{Shift}−1) and C_{Shift}=log₂ (w₁+w₂).

In some embodiments, step S340 may include:
dividing the current block into multiple regions;
determining, for a first region in the multiple regions, a weight value of the first prediction block in the first region and a weight value of the second prediction block in the first region; and
performing weighting processing on the first prediction block and the second prediction block in the first region by using the weight value of the first prediction block in the first region and the weight value of the second prediction block in the first region, to obtain the predicted value of the first region.

The target prediction block includes a predicted value of each region in the multiple regions.

For example, as shown in (a) in FIG. 6, when the current encoding block is vertically divided into four equal regions, the region indexes are respectively 0, 1, 2, and 3 in an order from left to right. As shown in (b) in FIG. 6, when the current encoding block is horizontally divided into four equal regions, the region indexes are respectively 0, 1, 2, and 3 in an order from top to bottom.

In some embodiments, the decoder divides the first region into multiple regions based on an index of the first prediction mode.

For example, the decoder determines a division manner of the current block based on the index of the first prediction mode. Then, the first region is divided into the multiple regions based on the division manner of the current block.

In some embodiments, if an index of the first prediction mode is in a first index range, the current block is vertically divided into the multiple regions.

For example, if the first prediction mode is an angular prediction mode, and an index of the first prediction mode is in the first index range, the current block is vertically divided into the multiple regions.

For example, as shown in (a) in FIG. 6, when the decoder vertically divides the current encoding block into four equal regions, the region indexes are respectively 0, 1, 2, and 3 in an order from left to right. For example, if the first prediction mode is an angular prediction mode, the first index range is [34, 66]. In other words, when 34<=intra_dir<=66, the decoder may horizontally divide the current block into four equal regions, and the region indexes are 0, 1, 2, and 3, respectively in an order from left to right. Intra_dir represents an index of the first prediction mode.

In some embodiments, if the index of the first prediction mode is in a second index range, the current block level is horizontally divided into the multiple regions.

For example, the first index range is different from the second index range.

For example, as shown in (b) in FIG. 6, when the current coding block is horizontally divided into four equal regions, region indexes are respectively 0, 1, 2, and 3 in an order from top to bottom. For example, if the first prediction mode is an angular prediction mode, the second index range is [2, 34). In other words, when 2≤intra_dir<34, the decoder may vertically divide the current block into four equal regions, and region indexes are respectively 0, 1, 2, and 3 in an order from left to right. Intra_dir represents an index of the first prediction mode.

In some embodiments, the weight value corresponding to the index of the first region includes a weight value of the first prediction block in the first region and a weight value of the second prediction block in the first region.

For example, the decoder determines one weight value corresponding to the index of the first region as a weight value of the first prediction block in the first region, and determines another weight value corresponding to the index of the first region as a weight value of the second prediction block in the first region.

For example, the decoder may determine the weight value of the first prediction block in the first region and the weight value of the second prediction block in the first region based on the index of the first region according to Table 4.

TABLE 4

| Index | (W₂, W₁) |
|---|---|
| 0 | (6, 2) |
| 1 | (5, 3) |
| 2 | (3, 5) |
| 3 | (2, 6) |

As shown in Table 4, W₁ represents a weight value of the first prediction block, and W₂ represents a weight value of the second prediction block. If the index of the first region is 0 and the index value corresponding to the first region is (6,2), in this case, it may be determined that the weight value of the first prediction block in the first region is 2, and the weight value of the second prediction block in the first region is 6. If the index of the first region is 1 and the index value corresponding to the first area is (5,3), in this case, it may be determined that the weight value of the first prediction block in the first region is 3, and the weight value of the second prediction block in the first region is 5. If the index of the first region is 2 and the index value corresponding to the first region is (3,5), in this case, it may be determined that the weight value of the first prediction block in the first region is 5, and the weight value of the second prediction block in the first region is 3. If the index of the first region is 3, and the index value corresponding to the first region is (6,2), in this case, it may be determined that the weight value of the first prediction block in the first region is 6, and the weight value of the second prediction block in the first region is 2.

Certainly, Table 4 is merely an example of this application, and should not be construed as a limitation of this application. For example, in other alternative embodiments, the values in Table 4 may be replaced with other values.

In some embodiments, both the weight value of the first prediction block in the first region and the weight value of the second prediction block in the first region are predefined weight values.

For example, if the first prediction mode is not an angular prediction mode, both the weight value of the first prediction block in the first region and the weight value of the second prediction block in the first region are predefined weight values.

For example, if the first prediction mode is the planar mode or DC mode, both the weight value of the first prediction block in the first region and the weight value of the second prediction block in the first region are predefined weight values.

For example, when the weight value of the first prediction block in the first region and the weight value of the second prediction block in the first region are both predefined weight values, (W₁, W₂) may be (1, 3) or another value, W₁ represents the weight value of the first prediction block, and W₂ represents the weight value of the second prediction block.

In some embodiments, the decoder may determine the weight value of the first prediction block in the first region and the weight value of the second prediction block in the first region based on at least one of the following:
encoding information of an adjacent encoding block, a size of the current block, a template size of the current block, a type of the first prediction mode, and a location of each region of the current block.

For example, the decoder may determine a weight value of the first prediction block in the first region (or a weight value of the second prediction block in the first region) based on at least one of: decoding information of an adjacent decoding block, a size of the current block, a template size of the current block, a type of the first prediction mode, or a location of each region of the current block, and then determine a weight value of the second prediction block in the first region (or a weight value of the first prediction block in the first region) based on a predefined total weight value and a weight value of the first prediction block in the first region (or a weight value of the second prediction block in the first region). For example, the decoder may determine a weight value corresponding to at least one of decoding information of an adjacent decoding block, a size of the current block, a template size of the current block, a type of the first prediction mode, or a location of each region of the current block, as a weight value of the first prediction block in the first region (or a weight value of the second prediction block in the first region). The weight value of the second prediction block in the first region (or the weight value of the first prediction block in the first region) is a difference between the total weight value and the weight value of the first prediction block in the first region (or the weight value of the second prediction block in the first region).

Certainly, the weight value of the first prediction block in the first region and the weight value of the second prediction block in the first region may also be determined in another manner. The determining manner is not limited in this application. For example, the weight value of the first prediction block in the first region and the weight value of the second prediction block in the first region may be determined by decoding the bitstream. In another example, the weight value of the first prediction block in the first region may be determined based on the template error value of the first prediction block, and then the weight value of the second prediction block in the first region is determined based on the predefined total weight value and the weight value of the first prediction block in the first region. For example, the weight value of the first prediction block in the first region is negatively correlated with a template error value of the single matching block, and the weight value of the second prediction block in the first region is a difference between the total weight value and the weight value of the first prediction block in the first region.

In some embodiments, the decoder adds C_{offset} to a value obtained by performing weighting processing on the first prediction block and the second prediction block in the first region to obtain a result, and performs right shift C_{Shift} on the result to obtain a prediction value of the first region. C_{offset} is a value determined according to C_{Shift}, and C_{Shift} is a value determined according to a sum of the weight value of the first prediction block in the first region and the weight value of the second prediction block in the first region.

For example, the decoder may determine the target prediction block by using the following formula:

$$Pred = ( {W}_{1}^{*} {pred}_{1} + {W}_{2}^{*} {pred}_{2} + {C}_{offset} ) >> {C}_{Shift} .$$

In which, Pred represents a predicted value of the first region, pred₁ represents a region corresponding to the first region in the first prediction block, W₁ represents a weight value of the first prediction block in the first region, pred₂ represents a region corresponding to the first region in the second prediction block, and W₂ represents a weight value of the second prediction block in the first region.

In some embodiments, C_{offset}=1<<(C_{Shift}−1), C_{Shift}=┌log2Wsum┐; ┌┐ is a ceiling operator, << is a left-shifted operator, and Wₛᵤₘ represents a sum of a weight value of the first prediction block in the first region and a weight value of the second prediction block in the first region.

For example, C_{offset}=1<<(C_{Shift}−1), C_{Shift}=log₂ (W₁+W₂).

In some embodiments, the template of the current block includes at least one of: a left reconstructed pixel, a lower left reconstructed pixel, an upper left reconstructed pixel, an upper reconstructed pixel, and an upper right reconstructed pixel of the current block.

For example, the left reconstructed pixel, the lower left reconstructed pixel, or the upper left reconstructed pixel includes one or more columns of reconstructed pixels.

For example, the upper left reconstructed pixel, the upper reconstructed pixel, or the upper right reconstructed pixel includes one or more rows of reconstructed pixels.

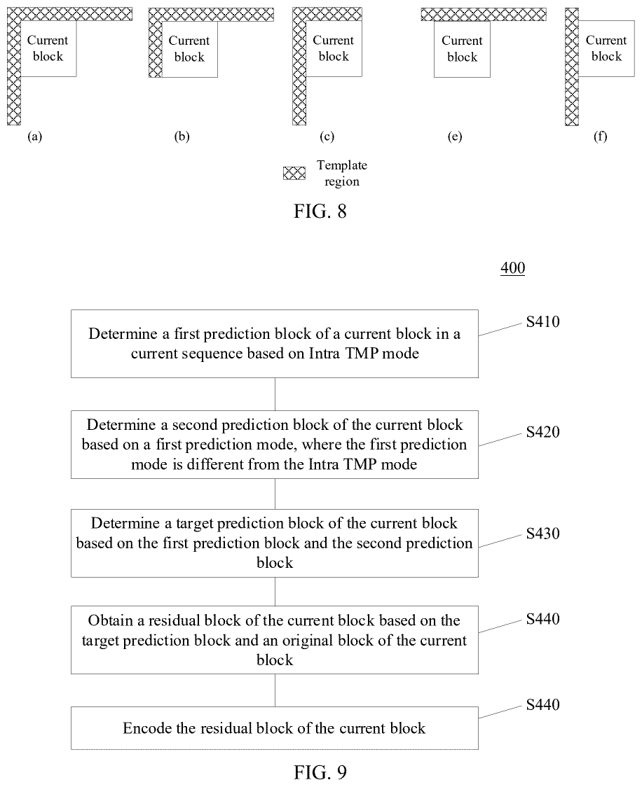

FIG. 8 is an example of a template of a current block according to an embodiment of this application.

As shown in (a) in FIG. 8, the template of the current block includes a left reconstructed pixel, a lower left reconstructed pixel, an upper left reconstructed pixel, an upper reconstructed pixel, and an upper right reconstructed pixel. As shown in (b) in FIG. 8, the template of the current block includes a left reconstructed pixel, an upper left reconstructed pixel, an upper reconstructed pixel, and an upper right reconstructed pixel. As shown in (c) in FIG. 8, the template of the current block includes a left reconstructed pixel, a lower left reconstructed pixel, an upper left reconstructed pixel, and an upper reconstructed pixel. As shown in (d) in FIG. 8, the template of the current block includes an upper left reconstructed pixel, an upper reconstructed pixel, and an upper right reconstructed pixel. As shown in (e) in FIG. 8, the template of the current block includes a left reconstructed pixel, a lower left reconstructed pixel, and an upper left reconstructed pixel.

In some embodiments, step S320 may include:
determining a condition for using the IntraTMP mode; and
in a case in which the condition is met, determining the first prediction block based on the IntraTMP mode.

In some embodiments, the condition is obtained by at least one of: a size of the current block, decoding information of the adjacent decoding block, a sequence-level flag bit, a frame-level flag bit, a macro block-level flag bit, a type of a slice in which the current block is located, or a frame type of an image frame in which the current block is located.

For example, in a case in which a condition for using the IntraTMP mode is met, the decoder decodes relates the first flag described above.

For example, in a case in which the condition for using the IntraTMP mode is met, the decoder decodes the first flag described above; and in a case in which the first flag indicates to use the IntraTMP mode, the decoder determines the first prediction block of the current block based on the IntraTMP mode.

For example, the condition includes at least one of: a size of the current block is greater than (or equal to or less than) a predefined size, decoding information of an adjacent decoding block is predefined decoding information, a value of a sequence-level flag bit is a predefined value, a value of a frame-level flag bit is a predefined value, a value of a macro block-level flag bit is a predefined value, a type of a slice in which the current block is located is a predefined type, and a frame type of an image frame in which the current block is located is a predefined type. The predefined information (for example, a predefined size, a predefined decoding information, a predefined value, and a predefined type) may be implemented by pre-storing a corresponding code, table, or another manner indicating related information in a device (for example, including a decoder), which is not limited in this application. For example, the predefined information may refer to information defined in a protocol. It should be further understood that, in embodiments of this application, the “protocol” may refer to a standard protocol in the coding field, for example, including an image coding field, a video coding field, a hardware video coding field, a dedicated circuit video coding field, a real-time video coding field, and a related protocol applied to a future coding system. This is not limited in this application.

For example, it is assumed that the condition includes that a frame type of an image frame in which the current block is located is a predefined type. In this case, the predefined type may be an I frame, that is, the condition includes that a frame type of an image frame in which the current block is located is an I frame. In other words, only when the image frame in which the current block is located is an I frame for intra prediction, the decoder may determine the first prediction block of the current block based on the IntraTMP mode.

In some embodiments, the first prediction mode is a prediction mode obtained by template-based intra mode derivation TIMD.

Certainly, in another alternative embodiment, the first prediction mode may also be a predefined prediction mode, or may be a prediction mode determined by decoding the bitstream decode or by another manner. This is not specifically limited in this application.

The following describes the preferred embodiments provided in this application.

### Embodiment 1

### Step 1

the decoder decodes inputted bitstream. The decoding process is performed according to a CTU sequence. According to the block division flag obtained by decoding, the CTU is divided into different encoding blocks for decoding. If the flag bit sps_tmp_enabled_flag in the SPS is equal to 1, and a size of the current coding block meets a limitation MaxTmpSize on a size of IntraTMP encoding block in the SPS, intra_tmp_flag is decoded. If intra_tmp_flag is equal to 1, it indicates that the current encoding block uses the IntraTMP mode to encode, and intra_tmp_ciip_flag is decoded. If intra_tmp_flag is equal to 0, it indicates that the current coding block does not use the IntraTMP mode to encode, and it is unnecessary to decode intra_tmp_ciip_flag. A process of decoding the related syntax element is shown in Table 3.

### Step 2

The syntax element intra_tmp_ciip_flag is decoded by using X context models. An index CtxIdxInc corresponding to different context models is determined according to encoding information of an adjacent encoding block and a size of the current encoding block. For example, X is equal to 3, and coordinates of the current coding block is (x, y). If an encoding block cuLeft exists at coordinates (x−1, y) and intra_tmp_ciip_flag of cuLeft is 1, CtxIdxInc is 1; otherwise, CtxIdxInc is 0. Then, if an encoding block cuAbove exists at coordinates (x, y−1) and intra_tmp_ciip_flag of cuAbove is 1, CtxIdxInc increases by 1; otherwise, CtxIdxInc increases by 0.

### Step 3

If intra_tmp_ciip_flag is equal to 1, it indicates that the current coding block uses IntraTMP combined fusion prediction including intra prediction. If intra_tmp_ciip_flag is equal to 0, it indicates that the current encoding block uses original IntraTMP prediction.

### Step 4

When it is obtained by decoding that intra_tmp_flag of the current encoding block is equal to 1 and intra_tmp_ciip_flag is equal to 1, the current encoding block uses the IntraTMP mode for encoding and uses the IntraTMP combined fusion prediction to acquire the prediction block of the current encoding block.

### Step 5

Intra-frame template matching is performed in the search area to obtain an optimal matching block, as prediction block 1 in a weighted fusion process (that is, the first prediction block described above). For example, a template error value (represented by an SAD between templates) of different block vectors (BV) is calculated by using a step size s (that is, every S points in the horizontal or vertical direction) in the search area of the current encoding block, to obtain a block vector BV0 with a minimum template error value. For example, if the currently matching block vector is (X0, Y0), a next matching block vector is (X0+S, Y0), and a vertical coordinate of a next matched block is Y0+4. If the step size s is greater than one pixel, BV0 is refined. Specifically, if the optimal matching block vector BV0 is (X0, Y0), it is determined that a refining distance L=(s/2)*H, where s is a template matching step size, and H is a height of the current encoding block. The refined range is a rectangular region of which the upper left corner is (Xi−L, Yi−L) and the lower right corner is (Xi+L, Yi+L). Template matching is performed in the rectangular region by using a step size s′ (s′=s/2), to obtain a block vector BV0′ with a minimum template error value, as the optimal matching block vector. When s′ is greater than one pixel, the pruning and refining process may be repeated until s′ is equal to 1. A matching block pred_tmp to which the optimal matching block vector points serves as the prediction block 1 in the weighted fusion process.

### Step 6

The prediction block 2 in the weighted fusion process (that is, the second prediction block described above) is obtained by using an intra prediction mode other than the IntraTMP. For example, an intra-frame encoding mode intra_dir of the current encoding block is obtained by using a template-based intra mode derivation (TIMD) technology. Intra prediction block pred_intra predicted by using intra_dir serves as the prediction block 2.

### Step 7

weight values are determined for the prediction block 1 and the prediction block 2. For example, the current encoding block is divided according to the intra-frame encoding mode intra_dir derived by using the TIMD in step 6, and different weight values are set for the IntraTMP prediction block and the intra prediction block in different regions. For example, ECM includes 65 intra-frame angular prediction modes (2≤intra_dir<=66). When 2≤intra_dir<34, the current encoding block is vertically divided into four equal regions. When 34<=intra_dir<=66, the current encoding block is horizontally divided into four equal regions. The weight value wTMP (that is, W₁ described above) of the prediction block 1 and the weight value wIntra (that is, W₂ in the foregoing) of the prediction block 2 in each region may be determined according to Table 4.

Specifically, when intra_dir is equal to 0 or 1, (wIntra, wTMP) is equal to (1,3).

### Step 8

Weighted fusion is performed on the prediction block 1 and the prediction block 2. For example, according to the obtained intra-frame template matching block pred_tmp, intra prediction block pred_intra, and weight values wTmp and wIntra, the final prediction block Pred is expressed as:

$$Pred = ( wTmp * pred\_tmp + wIntra * pred\_intra + offset ) >> \text{shift.}$$

$$In which , offset = 1 << ( shift - 1 ) , and Shift = {log}_{2} ( wTmp + wIntra ) .$$

### Step 9

A coefficient signal of the current encoding block is decoded, the residual block of the current encoding block is obtained by performing inverse quantization and inverse conversion, the prediction block Pred is added with the residual block to obtain a reconstructed block of the current encoding block, thereby completing decoding of the current encoding block.

The foregoing describes in detail the preferred implementations of this application with reference to the accompanying drawings. However, this application is not limited to specific details in the foregoing implementations. Within a technical concept scope of this application, multiple simple variations of the technical solutions of this application may be performed, and these simple variations all fall within the protection scope of this application. For example, specific technical features described in the foregoing specific implementations may be combined in any suitable manner without contradiction. To avoid unnecessary repetition, various possible combination manners are not described in this application. For another example, different implementations of this application may be combined randomly, provided that the combination is not contrary to the concept of this application, and the combination should also be considered as the content disclosed in this application. It should be further understood that in the various method embodiments of this application, a sequence number of the foregoing processes does not indicate an execution sequence. The execution sequence of the processes should be determined according to functions and internal logic of the processes, and should not constitute any limitation on an implementation process of the embodiments of this application.

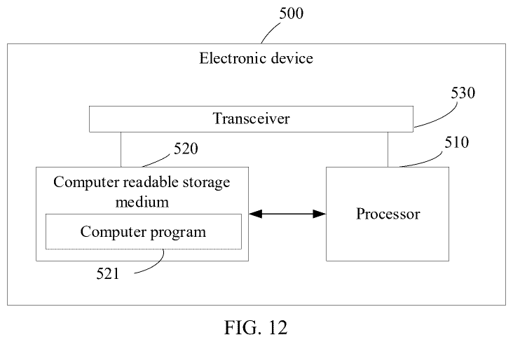

The foregoing describes the decoding method according to the embodiments of this application in detail from a perspective of the decoder. The following describes an encoding method according to the embodiments of this application from a perspective of an encoder with reference to FIG. 12.

FIG. 9 is a schematic flowchart of an encoding method according to an embodiment of this application. It should be understood that the encoding method 400 may be executed by the encoder. For example, the method is applied to the encoding framework shown in FIG. 1. For ease of description, the following describes the encoding method 400 by using the encoder as an example.

As shown in FIG. 9, the encoding method 400 may include the following steps S410 to S450.

In step S410, a first prediction block of a current block in a current sequence is determined based on an intra template matching prediction IntraTMP mode.

In step S420, a second prediction block of the current block is determined based on a first prediction mode. The first prediction mode is different from the IntraTMP mode;

In step S430, a target prediction block of the current block is determined based on the first prediction block and the second prediction block.

In step S440, a residual block of the current block is obtained based on the target prediction block and the original block of the current block.

In step S450, encoding is performed on the residual block of the current block.

In some embodiments, the method 400 may further include:
encoding the first flag.

The first flag indicates to perform fusion prediction by using the Intra TMP mode.

In some embodiments, the method 400 may further include:
encoding the second flag.

The second flag indicates to perform prediction by using the IntraTMP mode.

In some embodiments, the process of encoding the second flag includes:
determining a target context index; and
encoding the first flag by using the target context index.

In some embodiments, the process of determining a target context index includes:
determining the target context index based on decoding information of an adjacent decoding block of the current block; and/or
determining the target context index based on a size of the current block.

In some embodiments, coordinates of the current block are (x, y), and the adjacent decoding block includes a first decoding block whose coordinates are (x−1, y) and a second decoding block whose coordinates are (x, y−1). The decoding information of the first decoding block includes a prediction mode used by the first decoding block, and the decoding information of the second decoding block includes a prediction mode used by the second decoding block.

The process of determining the target context index based on decoding information of an adjacent decoding block of the current block includes:
if the prediction mode used by the first decoding block is a mode in which fusion prediction is performed based on the IntraTMP mode, assigning A to a first value; otherwise, assigning B to the first value, where Both A and B are integers;
if the prediction mode used by the second decoding block is a prediction mode in which fusion prediction is performed based on the IntraTMP mode, assigning C to a second value; otherwise, assigning D to the second value, where both C and D are integers; and
determining a sum of the first value and the second value as the target context index.

In some embodiments, step S410 may include:
performing template matching on the current block based on the IntraTMP mode to obtain an optimal matching block; and
determining the first prediction block based on the optimal matching block.

In some embodiments, the process of determining the first prediction block based on the optimal matching block includes:
determining the optimal matching block as the first prediction block; or
refining the optimal match block to obtain the first prediction block.

In some embodiments, the process of refining the optimal matching block to obtain the first prediction block includes:
determining a refinement range of the optimal matching block;
performing intra-frame template matching in the refinement range based on at least one matching step size, to obtain a matching block in the refinement range, where each matching step size in the at least one matching step size is less than a matching step size used by the optimal matching block;
determining a matching block with a minimum template error value among the matching block in the refinement range as the optimal matching block subjected to refinement; and
determining the optimal matching block subjected to refinement as the first prediction block.

In some embodiments, the process of determining a refinement range of the optimal matching block includes:
determining the refinement range based on a size of the current block and the optimal matching block.

In some embodiments, the process of determining the refinement range based on the size of the current block and the optimal matching block includes:
determining (S/F)*H as the refinement range by taking a block vector from the current block to the optimal matching block.

In which, / represents a division operator, * represents a multiplication operator, S represents a matching step size used by the optimal matching block, H represents a height of the current block, and F is a positive integer.

In some embodiments, the process of determining a refinement range of the optimal matching block includes:
determining the refinement range based on a predefined value.

In some embodiments, step S410 may include:
performing template matching on the current block based on the IntraTMP mode to obtain multiple matching blocks; and
performing weighting processing on the multiple matching blocks to obtain the first prediction block.

In some embodiments, the S430 includes:
determining a weight value of the first prediction block and a weight value of the second prediction block; and
performing weighting processing on the first prediction block and the second prediction block by using the weight value of the first prediction block and the weight value of the second prediction block, to obtain the target prediction block.

In some embodiments, the process of determining a weight value of the first prediction block and a weight value of the second prediction block includes:
determining the weight value of the first prediction block and the weight value of the second prediction block based on at least one of:
encoding information of an adjacent encoding block, a size of the current block, a template size of the current block, a type of the first prediction mode, and a location of each region of the current block.

In some embodiments, both the weight value of the first prediction block and the weight value of the second prediction block are predefined weight values.

In some embodiments, the process of performing weighting processing on the first prediction block and the second prediction block by using the weight value of the first prediction block and the weight value of the second prediction block to obtain the target prediction block includes:
adding C_{offset} to a value obtained by performing weighting processing on the first prediction block and the second prediction block to obtain a result, and performing right shift C_{Shift} on the result to obtain the target prediction block.

In which, C_{offset} is a value determined according to C_{Shift}, and C_{Shift} is a value determined according to a sum of the weight value of the first prediction block and the weight value of the second prediction block.

In some embodiments, C_{offset}=1<<(C_{Shift}−1), C_{Shift}=┌log₂Wₛᵤₘ┐; ┌┐ is a ceiling operator, << is a left-shifted operator, and Wₛᵤₘ represents a sum of the weight value of the first prediction block and the weight value of the second prediction block.

In some embodiments, step S430 includes:
dividing the current block into multiple regions;
determining, for a first region of the multiple regions, a weight value of the first prediction block in the first region and a weight value of the second prediction block in the first region; and
performing weighting processing on the first prediction block and the second prediction block in the first region by using the weight value of the first prediction block in the first region and the weight value of the second prediction block in the first region, to obtain a predicted value of the first region.

The target prediction block includes a predicted value of each region in the multiple regions.

In some embodiments, the process of dividing the current block into multiple regions includes:
dividing the first region into the multiple regions based on an index of the first prediction mode.

In some embodiments, the process of dividing the first region into the multiple regions based on the index of the first prediction mode includes:
if the index of the first prediction mode is in a first index range, dividing the current block vertically into the multiple regions; or
if the index of the first prediction mode is in a second index range, dividing the current block horizontally into the multiple region, where the first index range is different from the second index range.

In some embodiments, the weight value corresponding to the index of the first region includes a weight value of the first prediction block in the first region and a weight value of the second prediction block in the first region.

In some embodiments, both the weight value of the first prediction block in the first region and the weight value of the second prediction block in the first region are predefined weight values.

In some embodiments, the process of determining a weight value of the first prediction block in the first region and a weight value of the second prediction block in the first region includes:
determining a weight value of the first prediction block in the first region and a weight value of the second prediction block in the first region based on at least one of the following:
encoding information of an adjacent encoding block, a size of the current block, a template size of the current block, a type of the first prediction mode, and a location of each region of the current block.

In some embodiments, the process of performing weighting processing on the first prediction block and the second prediction block in the first region by using the weight value of the first prediction block in the first region and the weight value of the second prediction block in the first region to obtain the predicted value of the first region includes:
adding C_{offset} to a value obtained by performing weighting processing on the first prediction block and the second prediction block in the first region to obtain a result, and performing right shift C_{Shift} on the result to obtain a predicted value of the first region.

In which, C_{offset} is a value determined according to C_{Shift}, and C_{Shift} is a value determined according to a sum of the weight value of the first prediction block in the first region and the weight value of the second prediction block in the first region.

In some embodiments, C_{offset}=1<<(C_{Shift}−1), C_{Shift}=┌log₂Wₛᵤₘ┐; ┌┐ is a ceiling operator, << is a left-shifted operator, and Wₛᵤₘ represents a sum of a weight value of the first prediction block in the first region and a weight value of the second prediction block in the first region.

In some embodiments, the template of the current block includes at least one of: a left reconstructed pixel, a lower left reconstructed pixel, an upper left reconstructed pixel, an upper reconstructed pixel, and an upper right reconstructed pixel of the current block.

In some embodiments, step S410 includes:
determining a condition for using the IntraTMP mode; and
in a case in which the condition is met, determining the first prediction block based on the IntraTMP mode.

In some embodiments, the condition is obtained by at least one of the following: a size of the current block, decoding information of an adjacent decoding block, a sequence-level flag bit, a frame-level flag bit, a macro block-level flag bit, a type of a slice in which the current block is located, or a frame type of an image frame in which the current block is located.

In some embodiments, the first prediction mode is a prediction mode obtained by using template-based intra mode derivation TIMD.

It should be understood that the decoding method 300 is an inverse process or an inverse operation of the encoding method 400. Therefore, for steps in the encoding method 400, one may refer to corresponding steps in the decoding method 300. For brevity, details are not described herein again.

The following describes the preferred embodiments provided in this application.

### Embodiment 2

### Step 1

The encoder divides an inputted video signal into a CTU (Coding Tree Unit), and divides the CTU into CUs (Coding Unit, also referred to as coding block) with different sizes by using a binary tree, a triple tree or a quadtree for encoding. For a current encoding block, an available encoding mode is selected according to a mode flag bit in the SPS for encoding. When the IntraTMP mode flag bit sps_tmp_enabled_flag in the SPS is equal to 1 and a size of the current encoding block meets the IntraTMP encoding block size limitation in the SPS, the current encoding block may be encoded by using the IntraTMP mode.

### Step 2

If the current encoding block is encoded by using the IntraTMP mode, on the basis of the original IntraTMP prediction, the IntraTMP combined fusion prediction is used to predict and encode the current encoding block.

### Step 3

Intra-frame template matching is performed in a search area to obtain an optimal matching block as prediction block 1 in a weighted fusion process (that is, the first prediction block described above). For example, a template error value (represented by an SAD between templates) of different block vectors (BV) is calculated by using a step size s (that is, every S points in the horizontal or vertical direction) in the search area of the current encoding block, to obtain a block vector BV0 with a minimum template error value. For example, if the currently matching block vector is (X0, Y0), a next matching block vector is (X0+S, Y0), and a vertical coordinate of a next matched block is Y0+4. If the step size s is greater than one pixel, BV0 is refined. Specifically, if the optimal matching block vector BV0 is (X0, Y0), it is determined that a refining distance L=(s/2)*H, where s is a template matching step size, and H is a height of the current encoding block. The refined range is a rectangular region of which the upper left corner is (Xi−L, Yi−L) and the lower right corner is (Xi+L, Yi+L). Template matching is performed in the rectangular area by using a step size s′ (s′=s/2), to obtain a block vector BV0′ with a minimum error value of the template, as the optimal matching block vector. When s′ is greater than one pixel, the pruning and refining process may be repeated until s′ is equal to 1. A matching block pred_tmp to which the optimal matching block points serves as the prediction block 1 in the weighted fusion process;

### Step 4

The prediction block 2 in the weighted fusion process (that is, the second prediction block described above) is obtained by using the intra prediction mode other than the IntraTMP. For example, an intra-frame encoding mode intra_dir of a current encoding block is obtained by using a template-based intra mode derivation (TIMD) technology. Intra prediction block pred_intra precited by using intra_dir serves as the prediction block 2.

### Step 5

weight values are determined for the prediction block 1 and the prediction block 2. For example, the current encoding block is divided according to the intra-frame encoding mode intra_dir derived by the TIMD in step 3, and different weight values are set for the IntraTMP prediction block and the intra prediction block in different regions. For example, ECM includes 65 intra-frame angular prediction modes (2≤intra_dir<=66). When 2≤intr_dir<34, the current encoding block is vertically divided into four equal regions. When 34<=intra_dir<=66, the current coding block is horizontally divided into four equal regions. The weight value wTMP (that is, W₁ described above) of the prediction block 1 and the weight value wIntra (that is, W₂ in the foregoing) of the prediction block 2 in each region may be determined according to Table 4.

Specifically, when intra_dir is equal to 0 or 1, (wIntra, wTMP) is equal to (1,3).

### Step 6

Weighted fusion is performed on the prediction block 1 and the prediction block 2. For example, according to the obtained intra-frame template matching block pred_tmp, intra prediction block pred_intra, and weight values wTmp and wIntra, the final prediction block Pred is expressed as:

$$Pred = ( wTmp * pred\_tmp + wIntra * pred\_intra + offset ) >> \text{shift.}$$

$$In which , Offset = 1 << ( shift - 1 ) , and Shift = {log}_{2} ( wTmp + wIntra ) .$$

### Step 7

A residual block is generated based on the final prediction block Pred and the current encoding block. The residual block is compressed by subjecting to operations such as transformation, quantization and entropy coding, and is written into a bitstream, thereby completing encoding of the current encoding block. Inverse quantization and inverse transformation are performed on the residual block in the bitstream to obtain a reconstructed residual block. The reconstructed residual block is added with the prediction block Pred to obtain a reconstructed block of the current encoding block.

### Step 8

The flag bit intra_tmp_ciip_flag in the bitstream is used to indicate whether to perform the combined fusion prediction on the current encoding block. For example, if the current encoding block is encoded by using the IntraTMP mode encode, the flag bit intra_tmp_flag is equal to 1; in this case, intra_tmp_ciip_flag is written in the bitstream.

### Step 9

A syntax element intra_tmp_ciip_flag is encoded by using X context models. Indexes CtxIdxInc corresponding to different context models are determined according to encoding information of an adjacent encoding block and a size of the current encoding block. For example, X is equal to 3, and coordinates of the current encoding block are (x, y). If an encoding block cuLeft exists at coordinates (x−1, y) and cu_tmp_intra_flag of cuLeft is 1, CtxIdxInc is 1; otherwise, CtxIdxInc is 0. Then, if an encoding block cuAbove exists at coordinates (x, y−1) and cu_tmp_intra_flag of cuAbove is 1, CtxIdxInc is increased by 1; otherwise, CtxIdxInc is increased by 0.

### Step 10

Flag bit information such as intra_tmp_flag and intra_tmp_ciip_flag related to the IntraTMP combined fusion prediction is encoded by steps 8 to 9, and residual information obtained by the IntraTMP combined fusion prediction is encoded by step 7. A quantity of bits required by completing encoding of the current encoding block in the IntraTMP combined fusion prediction is determined according to the above encoding, and a rate distortion cost is calculated with reference to a distortion degree between the reconstructed block of the current encoding block and the current encoding block. The optimal encoding mode of the current encoding block is selected according to ratio distortion optimization (RDO), thereby completing encoding of the current encoding block.

It should be understood that for explanations of the flag bits in Embodiment 1 and Embodiment 2, one may refer to illustrations in Table 3. Details are not described herein again to avoid repetition. In addition, Embodiment 1 and Embodiment 2 are merely examples of this application, and should not be construed as a limitation to this application. For example, in another alternative embodiment, an extended solution of Embodiment 1 may be obtained based on Embodiment 1 and Embodiment 2. For example, the extended solution includes at least the following alternative solutions 1 to 12.

### Alternative Solution 1

In this solution, a part of the prediction block 1 is obtained by intra-frame template matching, and the intra-frame template matching may be combined with another IntraTMP-based mode. That is, a prediction block is obtained by using another template-based matching process as the prediction block 1, instead of obtaining a matching block by template matching as the prediction block 1.

For example, the present technology is combined with IntraTMP prediction in which multiple matching blocks are fused. In this case, step 3 and step 5 in which template matching is performed in embodiments are changed. The changed steps 3 and 5 include that: a template error value between a reconstructed block and the current encoding block in different locations may be obtained by intra-frame template matching, where the reconstructed block may be represented by a block vector from the current encoding block to the reconstructed block; a candidate block vector list is constructed to record a block vector with a smaller template error value during template matching; at least one block vector is selected from the candidate block vector list according to conditions such as block vector spacing and the template error value, and a reconstructed block to which the selected block vector points is used as a matching block of the current encoding block; a weight value is determined for each matching block of matching blocks; and weighted fusion is performed on the matching blocks according to weight values of the matching blocks to obtain a final prediction block. The prediction block is used as the prediction block 1.

When other IntraTMP-based modes are used, other modes may be combined with this solution by using multiple flag bits, as shown in Table 5 for example:

TABLE 5

| | |
|---|---|
| If (sps_tmp_enabled_flag && | |
| CbWidth <= MaxTmpSize && cbHeight <= MaxTmpSize) | |
| Intra_tmp_flag | Ae (v) |
| If (Intra_tmp_flag) { | |
| Intra_tmp_fusion_flag | |
| Intra_tmp_ciip_flag | Ae (v) |
| } | |
| Else { | |
| ... | |
| } | |

Explanations of the elements in Table 5 are as follows:

Intra_tmp_fusion_flag: encoding block flag bit, indicates whether the current encoding block is predicted by fused IntraTMP of multiple matching blocks. If the Intra_tmp_fusion_flag is equal to 1, the current encoding block is predicted by performing fusion on the multiple matching blocks. If the Intra_tmp_fusion flag is equal to 0, the current encoding block is predicted by using IntraTMP of a single matching block.

The codec first selects the IntraTMP prediction method according to the intra_tmp_fusion_flag. Then the codec determines whether to use this solution to perform weighted fusion on the prediction block obtained by the IntraTMP and the prediction block obtained by the intra prediction mode, according to the intra_tmp_ciip_flag.

### Alternative Solution 2

The template error value may be represented in different calculation manners, such as SATD, MSE, and MAD.

### Alternative Solution 3

The refinement region in the embodiments may be a region with another shape which is obtained according to information such as a predetermined value, the size of the current encoding block, a current block vector and a refinement step size, and is independent of a pruning range.

### Alternative Solution 4

The refining process may be skipped in embodiments of this application.

### Alternative Solution 5

The weight values of the prediction block 1 and the prediction block 2 may be predefined fixed values. The weight value is determined according to a template error value, a size of the current encoding block, known encoding information of an adjacent block, and the like. Different weight values may be set for different locations in the current block.

### Alternative Solution 6

syntax element intra_tmp_ciip_flag may not be written. The IntraTMP combined fusion prediction is used to replace the original IntraTMP prediction.

### Alternative Solution 7

A condition for IntraTMP combined fusion prediction may be added. The condition may be obtained by using information such as the size of the current encoding block, encoding information of an adjacent block, a sequence-level flag bit, a frame-level flag bit, and a macro block-level flag bit. When the condition is met, the syntax element intra_tmp_ciip_flag is encoded. Alternatively, when the constraint is met, the IntraTMP combined fusion prediction is used to replace the original IntraTMP mode.

### Alternative Solution 8

The syntax element intra_tmp_ciip_flag may be encoded by using another quantity of context modes. An index of the used context model is determined according to the size of the current encoding block and encoding information of the adjacent block. Alternatively, the syntax element intra_tmp_ciip_flag is encoded by using a bypass encoding mode.

### Alternative Solution 9

When only a part of templates on the left or upper side of the current encoding block are available, this part of templates may be used to perform the operations related to the templates in the embodiments.

### Alternative Solution 10

The template is L columns and M rows of adjacent reconstructed pixels located on the left and upper sides of the current block. L and M may be any integer value.

### Alternative Solution 11

The template may contain reconstructed pixels located at top right and bottom left of the current block. For example, the template may include five cases as shown in FIG. 8.

### Alternative Solution 12

The step size s of the search process and the step size s′ of the refinement process in the embodiments may be any integer value, where s′ is less than s. A multi-rounds of refining process may be performed, and a step size s′ of each round is less than a step size s′ of a previous round. Each refining region may be a region with other size or shape, which is associated with step size s or s′.

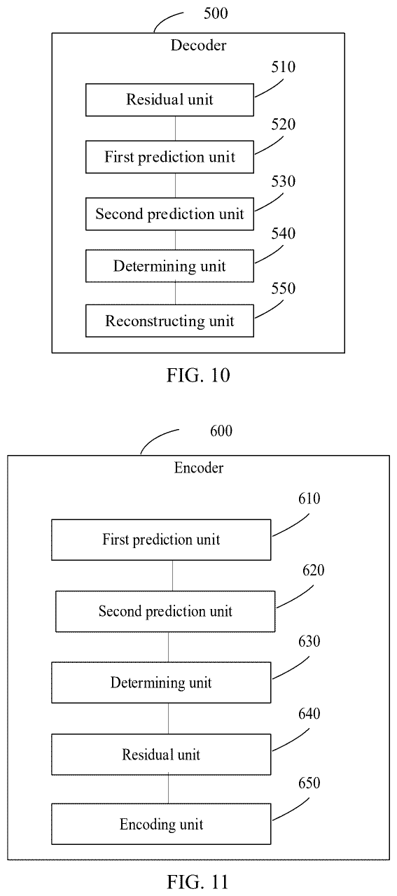

The foregoing describes in detail the method embodiments of this application. With reference to FIG. 10 to FIG. 12, the following describes in detail the apparatus embodiments of this application.

FIG. 10 is a schematic block diagram of a decoder 500 according to an embodiment of this application.

As shown in FIG. 10, the decoder 500 may include: a first residual unit 510, a first prediction unit 520, a second prediction unit 530, a determining unit 540 and a reconstruction unit 550.

The residual unit 510 is configured to determine a residual block of a current block in a current sequence based on a bitstream.

The first prediction unit 520 is configured to determine a first prediction block of the current block based on an intra template matching prediction IntraTMP mode.

The second prediction unit 530 is configured to determine a second prediction block of the current block based on a first prediction mode. The first prediction mode is different from the Intra TMP mode.

The determining unit 540 is configured to determine a target prediction block of the current block based on the first prediction block and the second prediction block.

The reconstruction unit 550 is configured to obtain a reconstructed block of the current block based on the residual block and the target prediction block of the current block.

In some embodiments, the first prediction unit 520 is specifically configured to:
determine a first flag based on the bitstream; and
if the first flag indicates to perform fusion prediction by using the IntraTMP mode, determine the first prediction block based on the IntraTMP mode.

In some embodiments, the first prediction unit 520 is specifically configured to:
determine a second flag based on the bitstream; and
if the second flag indicates to perform prediction by using the IntraTMP mode, determine the first flag based on the bitstream.

In some embodiments, the first prediction unit 520 is specifically configured to:
determine a target context index; and
determine the first flag by using the target context index based on the bitstream.

In some embodiments, the first prediction unit 520 is specifically configured to:
determine the target context index based on decoding information of an adjacent decoding block of the current block: and/or
determine the target context index based on a size of the current block.

In some embodiments, coordinates of the current block are (x, y), and the adjacent decoding block includes a first decoding block whose coordinates are (x−1, y) and a second decoding block whose coordinates are (x, y−1). Decoding information of the first decoding block includes a prediction mode used by the first decoding block, and decoding information of the second decoding block includes a prediction mode used by the second decoding block.

The first prediction unit 520 is specifically configured to:
if the prediction mode used by the first decoding block is a mode in which fusion prediction is performed based on the IntraTMP mode, assign A to a first value; otherwise, assign B to the first value, where both A and B are integers;
if the prediction mode used by the second decoding block is a prediction mode in which fusion prediction is performed based on the IntraTMP mode, assign C to a second value; otherwise, assign D to the second value, where both C and D are integers; and
determine a sum of the first value and the second value as the target context index.

In some embodiments, the first prediction unit 520 is specifically configured to:
perform template matching on the current block based on the IntraTMP mode to obtain an optimal matching block; and
determine the first prediction block based on the optimal matching block.

In some embodiments, the first prediction unit 520 is specifically configured to:
determine the optimal matching block as the first prediction block; or
refining the optimal matching block to obtain the first prediction block.

In some embodiments, the first prediction unit 520 is specifically configured to:
determine a refinement range of the optimal matching block;
perform intra-frame template matching in the refinement range based on at least one matching step size, to obtain a matching block in the refinement range, where each matching step size in the at least one matching step size is less than a matching step size used by the optimal matching block;
determine a matching block with a minimum template error value among the matching block in the refinement range as the optimal matching block subjected to refinement; and
determine the optimal matching block subjected to refinement as the first prediction block.

In some embodiments, the first prediction unit 520 is specifically configured to:
determine the refinement range based on the size of the current block and the optimal matching block.

In some embodiments, the first prediction unit 520 is specifically configured to:
determine (S/F)*H as the refinement range by taking a block vector from the current block to the optimal matching block as a center.

In which, / represents a division operator, * represents a multiplication operator, S represents a matching step size used by the optimal matching block, H represents a height of the current block, and F is a positive integer.

In some embodiments, the first prediction unit 520 is specifically configured to:
determine the refinement range based on a predefined value.

In some embodiments, the first prediction unit 520 is specifically configured to:
perform template matching on the current block based on the IntraTMP mode to obtain multiple matching blocks; and
perform weighting processing on the multiple matching blocks to obtain the first prediction block.

In some embodiments, the determining unit 530 is specifically configured to:
determine a weight value of the first prediction block and a weight value of the second prediction block; and
perform weighting processing on the first prediction block and the second prediction block by using the weight value of the first prediction block and the weight value of the second prediction block, to obtain the target prediction block.

In some embodiments, the determining unit 530 is specifically configured to:
determine a weight value of the first prediction block and a weight value of the second prediction block based on at least one of:
encoding information of an adjacent encoding block, a size of the current block, a template size of the current block, a type of the first prediction mode, and a location of each region of the current block.

In some embodiments, both the weight value of the first prediction block and the weight value of the second prediction block are predefined weight values.

In some embodiments, the determining unit 530 is specifically configured to:
add C_{offset} to a value obtained by performing weighting processing on the first prediction block and the second prediction block to obtain a result, and perform right shift C_{Shift} on the result to obtain the target prediction block.

In which, C_{offset} is a value determined according to C_{Shift}, and C_{Shift} is a value determined according to a sum of the weight value of the first prediction block and the weight value of the second prediction block.

In some embodiments, C_{offset}=1<<(C_{Shift}−1), C_{Shift}=┌log₂Wₛᵤₘ┐; ┌┐ is a ceiling operator, << is a left-shifted operator, and Wₛᵤₘ represents a sum of the weight value of the first prediction block and the weight value of the second prediction block.

In some embodiments, the determining unit 530 is specifically configured to:
divide the current block into multiple regions;
determine, for a first region in the multiple regions, a weight value of the first prediction block in the first region and a weight value of the second prediction block in the first region; and
perform weighting processing on the first prediction block and the second prediction block in the first region by using the weight value of the first prediction block in the first region and the weight value of the second prediction block in the first region, to obtain a predicted value of the first region.

The target prediction block includes a predicted value of each region in the multiple regions.

In some embodiments, the determining unit 530 is specifically configured to:
divide the first region into the multiple regions based on an index of the first prediction mode.

In some embodiments, the determining unit 530 is specifically configured to:
if the index of the first prediction mode is in a first index range, divide the current block vertically into the multiple regions; or
if the index of the first prediction mode is in a second index range, divide the current block horizontally into the multiple regions, where the first index range is different from the second index range.

In some embodiments, the weight value corresponding to the index of the first region includes a weight value of the first prediction block in the first region and a weight value of the second prediction block in the first region.

In some embodiments, both the weight value of the first prediction block in the first region and the weight value of the second prediction block in the first region are predefined weight values.

In some embodiments, the determining unit 530 is specifically configured to:
determine a weight value of the first prediction block in the first region and a weight value of the second prediction block in the first region based on at least one of:
encoding information of an adjacent encoding block, a size of the current block, a template size of the current block, a type of the first prediction mode, and a location of each region of the current block.

In some embodiments, the determining unit 530 is specifically configured to:
add C_{offset} to a value obtained by performing weighting processing on the first prediction block and the second prediction block in the first region to obtain a result, and perform right shift C_{Shift} on the result to obtain a predicted value of the first region.

In which, C_{offset} is a value determined according to C_{Shift}, and C_{Shift} is a value determined according to a sum of the weight value of the first prediction block in the first region and the weight value of the second prediction block in the first region.

In some embodiments, C_{offset}=1<<(C_{Shift}−1), C_{Shift}=┌log₂Wₛᵤₘ┐; ┌┐ is a ceiling operator, << is a left-shifted operator, and Wₛᵤₘ represents a sum of a weight value of the first prediction block in the first region and a weight value of the second prediction block in the first region.

In some embodiments, the template of the current block includes at least one of: a left reconstructed pixel, a lower left reconstructed pixel, an upper left reconstructed pixel, an upper reconstructed pixel, and an upper right reconstructed pixel of the current block.

In some embodiments, the first prediction unit 520 is specifically configured to:
determine a condition for using the IntraTMP mode; and
in a case in which the condition is met, determine the first prediction block based on the Intra TMP mode.

In some embodiments, the condition is obtained by at least one of: a size of the current block, decoding information of an adjacent decoding block, a sequence-level flag bit, a frame-level flag bit, a macro block level-flag bit, a type of a slice in which the current block is located, or a frame type of an image frame in which the current block is located.

In some embodiments, the first prediction mode is a prediction mode obtained by using template-based intra mode derivation TIMD.

FIG. 11 is a schematic block diagram of an encoder 600 according to an embodiment of this application.

As shown in FIG. 11, the encoder 600 may include: a first prediction unit 60, a second prediction unit 620, a determining unit 630, a residual unit 640 and an encoding unit 650.

The first prediction unit 610 is configured to determine a first prediction block of a current block in a current sequence based on an intra template matching prediction IntraTMP mode.

The second prediction unit 620 is configured to determine a second prediction block of the current block based on a first prediction mode. The first prediction mode is different from the Intra TMP mode.

The determining unit 630 is configured to determine a target prediction block of the current block based on the first prediction block and the second prediction block.

The residual unit 640 is configured to obtain a residual block of the current block based on the target prediction block and an original block of the current block.

The encoding unit 650 is configured to encode the residual block of the current block.

In some embodiments, the encoding unit 650 is further configured to:
encode a first flag,
where the first flag indicates to perform fusion prediction by using the IntraTMP mode.

In some embodiments, the encoding unit 650 is further configured to:
encode a second flag,
where the second flag indicates to perform prediction by using the IntraTMP mode.

In some embodiments, the encoding unit 650 is specifically configured to:
determine a target context index; and
encode the first flag by using the target context index.

In some embodiments, the encoding unit 650 is specifically configured to:
determine the target context index based on decoding information of an adjacent decoding block of the current block: and/or
determine the target context index based on the size of the current block.

In some embodiments, coordinates of the current block are (x, y), and the adjacent decoding block includes a first decoding block whose coordinates are (x−1, y) and a second decoding block whose coordinates are (x, y−1). Decoding information of the first decoding block includes a prediction mode used by the first decoding block, and decoding information of the second decoding block includes a prediction mode used by the second decoding block.

The encoding unit 650 is specifically configured to:
if the prediction mode used by the first decoding block is a mode in which fusion prediction is performed based on the IntraTMP mode, assign A to a first value; otherwise, assign B to the first value, where both A and B are integers;
if the prediction mode used by the second decoding block is a prediction mode in which fusion prediction is performed based on the IntraTMP mode, assign C to a second value; otherwise, assign D to the second value, where both C and D are integers; and
determine a sum of the first value and the second value as the target context index.

In some embodiments, the first prediction unit 610 is specifically configured to:
perform template matching on the current block based on the IntraTMP mode to obtain an optimal matching block; and
determine the first prediction block based on the optimal matching block.

In some embodiments, the first prediction unit 610 is specifically configured to:
determine the optimal matching block as the first prediction block; or
refining the optimal matching block to obtain the first prediction block.

In some embodiments, the first prediction unit 610 is specifically configured to:
determine a refinement range of the optimal matching block;
perform intra-frame template matching in the refinement range based on at least one matching step size, to obtain a matching block in the refinement range, where each matching step size in the at least one matching step size is less than a matching step size used by the optimal matching block;
determine a matching block with a minimum template error value among the matching block in the refinement range as the optimal matching block subjected to refinement; and
determine the optimal matching block subjected to refining as the first prediction block.

In some embodiments, the first prediction unit 610 is specifically configured to:
determining the refinement range based on the size of the current block and the optimal matching block.

In some embodiments, the first prediction unit 610 is specifically configured to:
determine (S/F)*H as the refinement range by taking a block vector from the current block to the optimal matching block as a center.

In which, / represents a division operator, * represents a multiplication operator, S represents a matching step size used by the optimal matching block, H represents a height of the current block, and F is a positive integer.

In some embodiments, the first prediction unit 610 is specifically configured to:
determine the refinement range based on a predefined value.

In some embodiments, the first prediction unit 610 is specifically configured to:
perform template matching on the current block based on the IntraTMP mode to obtain multiple matching blocks; and
perform weighting processing on the multiple matching blocks to obtain the first prediction block.

In some embodiments, the determining unit 630 is specifically configured to:
determine a weight value of the first prediction block and a weight value of the second prediction block; and
performing weighting processing on the first prediction block and the second prediction block by using the weight value of the first prediction block and the weight value of the second prediction block, to obtain the target prediction block.

In some embodiments, the determining unit 630 is specifically configured to:
determine a weight value of the first prediction block and a weight value of the second prediction block based on at least one of:
encoding information of an adjacent encoding block, a size of the current block, a template size of the current block, a type of the first prediction mode, and a location of each region of the current block.

In some embodiments, both the weight value of the first prediction block and the weight value of the second prediction block are predefined weight values.

In some embodiments, the determining unit 630 is specifically configured to:
add C_{offset} to a value obtained by performing weighting processing on the first prediction block and the second prediction block to obtain a result, and perform right shift C_{Shift} on the result to obtain the target prediction block.

In which, C_{offset} is a value determined according to C_{Shift}, and C_{Shift} is a value determined according to a sum of the weight value of the first prediction block and the weight value of the second prediction block.

In some embodiments, C_{offset}=1<<(C_{Shift}−1), C_{Shift}=┌log₂Wₛᵤₘ┐; ┌┐ is a ceiling operator, << is a left-shifted operator, and Wₛᵤₘ represents a sum of the weight value of the first prediction block and the weight value of the second prediction block.

In some embodiments, the determining unit 630 is specifically configured to:
divide the current block into multiple regions;
determine, for a first region in the multiple regions, a weight value of the first prediction block in the first region and a weight value of the second prediction block in the first region; and
perform weighting processing on the first prediction block and the second prediction block in the first region by using the weight value of the first prediction block in the first region and the weight value of the second prediction block in the first region, to obtain a predicted value of the first region.

The target prediction block includes a predicted value of each region in the multiple regions.

In some embodiments, the determining unit 630 is specifically configured to:
divide the first region into the multiple regions based on an index of the first prediction mode.

In some embodiments, the determining unit 630 is specifically configured to:
if the index of the first prediction mode is in a first index range, divide the current block vertically into the multiple regions; or
if the index of the first prediction mode is in a second index range, dividing the current block horizontally into the multiple regions, where the first index range is different from the second index range.

In some embodiments, the weight value corresponding to the index of the first region includes a weight value of the first prediction block in the first region and a weight value of the second prediction block in the first region.

In some embodiments, both the weight value of the first prediction block in the first region and the weight value of the second prediction block in the first region are predefined weight values.

In some embodiments, the determining unit 630 is specifically configured to:
determine a weight value of the first prediction block in the first region and a weight value of the second prediction block in the first region based on at least one of:
encoding information of an adjacent encoding block, a size of the current block, a template size of the current block, a type of the first prediction mode, and a location of each region of the current block.

In some embodiments, the determining unit 630 is specifically configured to:
add C_{offset} to a value obtained by performing weighting processing on the first prediction block and the second prediction block in the first region to obtain a result, and perform right shift C_{Shift} on the result to obtain a predicted value of the first region.

In which, C_{offset} is a value determined according to C_{Shift}, and C_{Shift} is a value determined according to a sum of the weight value of the first prediction block in the first region and the weight value of the second prediction block in the first region.

In some embodiments, C_{offset}=1<<(C_{Shift}−1), C_{Shift}=┌log₂Wₛᵤₘ┐; ┌┐ is a ceiling operator, << is a left-shifted operator, and Wₛᵤₘ represents a sum of the weight value of the first prediction block in the first region and the weight value of the second prediction block in the first region.

In some embodiments, the template of the current block includes at least one of: a left reconstructed pixel, a lower left reconstructed pixel, an upper left reconstructed pixel, an upper reconstructed pixel, and an upper right reconstructed pixel of the current block.

In some embodiments, the first prediction unit 610 is specifically configured to:
determine a condition for using the Intra TMP mode; and
in a case in which the condition is met, determine the first prediction block based on the Intra TMP mode.

In some embodiments, the condition is obtained by at least one of: a size of the current block, decoding information of an adjacent decoding block, a sequence-level flag bit, a frame-level flag bit, a macro block-level flag bit, a type of a slice in which the current block is located, or a frame type of an image frame in which the current block is located.

In some embodiments, the first prediction mode is a prediction mode obtained by using template-based intra mode derivation TIMD.

It should be understood that the apparatus embodiment may correspond to the method embodiment. For similar description, reference may be made to the method embodiments. To avoid repetition, details are not described herein again. Specifically, the decoder 500 shown in FIG. 10 may correspond to a subject performing the method 300 according to the embodiments of this application, and the foregoing and other operations and/or functions of the units in the decoder 500 are implemented to perform corresponding procedures in the methods such as the method 300. Similarly, the encoder 600 shown in FIG. 11 may correspond to a subject performing the method 400 according to the embodiments of this application, and the foregoing and other operations and/or functions of the units in the encoder 600 are implemented to perform corresponding procedures in the methods such as the method 400.

It should be further understood that units in the decoder 500 or the encoder 600 involved in embodiments of this application may be separately or completely combined into one or more other units, or one or more of the units may be divided into multiple units that are functionally smaller. This may implement a same operation without affecting implementation of the technical effect of the embodiments of this application. The foregoing units are divided based on logical functions. In actual application, functions of one unit may be implemented by multiple units, or functions of multiple units are implemented by one unit. In another embodiment of this application, the decoder 500 or the encoder 600 may include another unit. In actual application, these functions may also be implemented by another unit, and may be implemented by multiple units in cooperation. According to another embodiment of this application, a computer program (including program code) that can execute steps involved in the corresponding method may be run on a general-purpose computing device of a general-purpose computer that includes a processing element such as a central processing unit (CPU), a random access storage medium (RAM), a read-only storage medium (ROM), and a storage element, to construct the decoder 500 or the encoder 600 involved in the embodiments of this application, to implement the encoding method or the decoding method in embodiments of this application. The computer program may be recorded in, for example, a computer readable storage medium, and is installed in an electronic device via the computer readable storage medium, so as to implement the corresponding method in embodiments of this application by running the computer program in the electronic device.

In other words, the foregoing units may be implemented by hardware, may be implemented by software instructions, or may be implemented by a combination of software and hardware. Specifically, the steps of the method embodiments in this application may be completed by using an integrated logic circuit of hardware in the processor and/or an instruction in a form of software. The steps of the method disclosed with reference to the embodiments of this application may be directly performed by the hardware decoding processor, or may be performed by using a combination of hardware and software in the decoding processor. Optionally, the software may be located in a mature storage medium in the art such as a random access memory, a flash memory, a read-only memory, a programmable read-only memory, an electrically erasable programmable memory, and a register. The storage medium is located in a memory. The processor reads information in the memory and completes steps in the foregoing method embodiments with reference to hardware of the processor.

FIG. 12 is a schematic structural diagram of an electronic device 700 according to an embodiment of this application.

As shown in FIG. 12, the electronic device 700 includes at least a processor 710 and a computer readable storage medium 720. The processor 710 and the computer readable storage medium 720 may be connected by using a bus or in another manner. The computer readable storage medium 720 is configured to store a computer program 721. The computer program 721 includes a computer instruction. The processor 710 is configured to execute the computer instruction stored in the computer readable storage medium 720. The processor 710 is a computing core and a control core of the electronic device 700, and is adapted to implement one or more computer instructions, and is specifically adapted to load and execute one or more computer instructions, so as to implement the corresponding method procedure or the corresponding function.

As an example, the processor 710 may also be referred to as a Central Processing Unit (CPU). The processor 710 may include but is not limited to a general purpose processor, a digital signal processor (DSP), an application specific integrated circuit (ASIC), a Field Programmable Gate Array (FPGA) or another programmable logic device, a discrete element gate or transistor logic device, a discrete hardware component, or the like.

As an example, the computer readable storage medium 720 may be a high-speed RAM memory, or may be a non-volatile memory, for example, at least one disk memory. Optionally, the processor 710 may also be at least one computer readable storage medium far away from the processor 710. Specifically, the computer readable storage medium 720 includes but is not limited to a volatile memory and/or a non-volatile memory. The non-volatile memory may be a Read-Only Memory (ROM), a Programmable ROM (Programmable ROM, PROM), an Erasable PROM (Erasable PROM, EPROM), an Electrically EPROM (Electrically EPROM, EEPROM), or a flash memory. The volatile memory may be a Random Access Memory (RAM) that serves as an external cache. By way of examples rather than limitation, many forms of RAM may be used, such as Static RAM (SRAM), Dynamic RAM (DRAM), Synchronous DRAM (SDRAM), Double Data Rate SDRAM (DDR SDRAM), Enhanced SDRAM (ESDRAM), synch link DRAM (SLDRAM) and Direct Rambus RAM (DR RAM).

In an implementation, the electronic device 700 may be the encoder or the encoding framework involved in the embodiments of this application. The computer readable storage medium 720 stores a first computer instruction. The processor 710 loads and executes the first computer instruction stored in the computer readable storage medium 720, so as to implement corresponding steps in the encoding method provided in embodiments of this application. In other words, the first computer instruction in the computer readable storage medium 720 is loaded by the processor 710 to perform corresponding steps. To avoid repetition, details are not described herein again.

In an implementation, the electronic device 700 may be the decoder or the decoding framework involved in embodiments of this application. The computer readable storage medium 720 stores a second computer instruction. The processor 710 loads and executes the second computer instruction stored in the computer readable storage medium 720, so as to implement corresponding steps in the decoding method provided in embodiments of this application. In other words, the second computer instruction in the computer readable storage medium 720 is loaded by the processor 710 to perform corresponding steps. To avoid repetition, details are not described herein again.

According to another aspect of this application, an embodiment of this application further provides a coding system, including the foregoing encoder and decoder.

According to another aspect of this application, an embodiment of this application further provides a computer readable storage medium (Memory), where the computer readable storage medium is a memory device in an electronic device 700, and is configured to store a program and data. For example, the computer readable storage medium 720. It may be understood that the computer readable storage medium 720 herein may include a built-in storage medium in the electronic device 700, and certainly may also include an extended storage medium supported by the electronic device 700. The computer readable storage medium provides a storage space, and the storage space stores an operating system of the electronic device 700. In addition, the storage space further stores one or more computer instructions that are adaptable to be loaded and executed by the processor 710. These computer instructions may be one or more computer programs 721 (including program code).

According to another aspect of this application, a computer program product or a computer program is provided, where the computer program product or the computer program includes a computer instruction, and the computer instruction is stored in a computer readable storage medium, for example, the computer program 721. In this case, the data processing device 700 may be a computer. The processor 710 reads the computer instruction from the computer readable storage medium 720, and the processor 710 executes the computer instruction, so that the computer executes the encoding method or the decoding method provided in the foregoing optional implementations.

In other words, when software is used, the technical solutions of this application may be implemented in the form of a computer program product in whole or in part. The computer program product includes one or more computer instructions. When the computer program instruction is loaded and executed by the computer, a process of the embodiments of this application is completely or partially run or a function of the embodiments of this application is implemented. The computer may be a general-purpose computer, a dedicated computer, a computer network, or another programmable apparatus. The computer instruction may be stored in a computer readable storage medium or transmitted from one computer readable storage medium to another computer readable storage medium. For example, the computer instruction may be transmitted from one website site, computer, server, or data center to another website site, computer, server, or data center in a wired (such as coaxial cable, optical fiber, digital subscriber line (DSL)), or wireless (such as infrared, wireless, and microwave) manner.

A person of ordinary skill in the art may recognize that, schematic units and procedure steps described in the embodiments disclosed herein, may be implemented by electronic hardware or a combination of computer software and electronic hardware. Whether these functions are implemented in hardware or software depends on the specific application and design constraints of the technical solution. A person skilled in the art may use different methods for each specific application to implement the described functions, but this implementation should not be regarded to go beyond the scope of this application.

Finally, it should be noted that the foregoing content is merely a specific implementation of this application, and the protection scope of this application is not limited thereto. Any change or replacement readily figured out by a person skilled in the art within the technical scope disclosed by this application shall fall within the protection scope of this application. Therefore, the protection scope of this application shall be defined by the protection scope of the claims.

What is claimed is:

1. A decoding method, comprising:
determining a residual block of a current block in a current sequence based on a bitstream;
determining a first prediction block of the current block based on an intra template matching prediction IntraTMP mode;
determining a second prediction block of the current block based on a first prediction mode; wherein the first prediction mode is different from the IntraTMP mode;
determining a target prediction block of the current block based on the first prediction block and the second prediction block; and
obtaining a reconstruction block of the current block based on the residual block and the target prediction block of the current block.

2. The method according to claim 1, wherein the determining a first prediction block of the current block based on the IntraTMP mode comprises:
determining a first flag based on the bitstream; and
if the first flag indicates that fusion prediction is to be performed by using the IntraTMP mode, determining the first prediction block based on the IntraTMP mode.

3. The method according to claim 2, wherein the determining the first flag based on the bitstream comprises:
determining a target context index; and
determining the first flag by using the target context index based on the bitstream.

4. The method according to claim 1, wherein the determining the first prediction block based on the optimal matching block comprises:
determining the optimal matching block as the first prediction block; or
refining the optimal matching block to obtain the first prediction block.

5. The method according to claim 1, wherein the determining the first prediction block based on the intra template matching prediction IntraTMP mode comprises:
performing template matching on the current block based on the IntraTMP mode, to obtain a plurality of matching blocks; and
performing weighting processing on the plurality of matching blocks to obtain the first prediction block.

6. The method according to claim 1, wherein the determining the weight value of the first prediction block and the weight value of the second prediction block comprises:
determining the weight value of the first prediction block and the weight value of the second prediction block based on at least one of: coding information of an adjacent coding block, a size of the current block, a template size of the current block, a type of the first prediction mode, and a location of each area in the current block.

7. The method according to claim 1, wherein the determining the target prediction block of the current block based on the first prediction block and the second prediction block comprises:
dividing the current block into a plurality of regions;
determining, for a first region in the plurality of regions, a weight value of the first prediction block for the first region and a weight value of the second prediction block for the first region; and
performing weighting processing on the first prediction block and the second prediction block in the first region by using the weight value of the first prediction block for the first region and the weight value of the second prediction block for the first region, to obtain a prediction value of the first region,
wherein the target prediction block comprises a prediction value of each region in the plurality of regions.

8. The method according to claim 7, wherein the dividing the current block into the plurality of regions comprises:
dividing the first region into a plurality of regions based on the first prediction mode.

9. The method according to claim 1, wherein a template of the current block comprises at least one of a left reconstructed pixel, a lower left reconstructed pixel, an upper left reconstructed pixel, an upper reconstructed pixel, and an upper right reconstructed pixel of the current block.

10. The method according to claim 1, wherein the first prediction mode is a prediction mode obtained by template-based intra mode derivation TIMD.

11. An encoding method, comprising:
determining a first prediction block of a current block in a current sequence based on an intra template matching prediction IntraTMP mode;
determining a second prediction block of the current block based on a first prediction mode, wherein the first prediction mode is different from the IntraTMP mode;
determining a target prediction block of the current block based on the first prediction block and the second prediction block;
obtaining a residual block of the current block based on the target prediction block and an original block of the current block; and
encoding the residual block of the current block.

12. The method according to claim 11, further comprising:
encoding a first flag, wherein the first flag indicates to perform fusion prediction by using the Intra TMP mode.

13. The method according to claim 12, wherein the encoding the first flag comprises:
determining a target context index;
encoding the first flag by using the target context index.

14. The method according to claim 11, wherein the determining the first prediction block based on the optimal matching block comprises:
determining the optimal matching block as the first prediction block; or
refining the optimal matching block to obtain the first prediction block.

15. The method according to claim 11, wherein the determining the first prediction block of the current block in the current sequence based on the intra template matching prediction IntraTMP mode comprises:
performing template matching on the current block based on the IntraTMP mode, to obtain a plurality of matching blocks; and
performing weighting processing on the plurality of matching blocks to obtain the first prediction block.

16. The method according to claim 11, wherein the determining the weight value of the first prediction block and the weight value of the second prediction block comprises:
determining the weight value of the first prediction block and the weight value of the second prediction block based on at least one of: encoding information of an adjacent coding block, a size of the current block, a template size of the current block, a type of the first prediction mode, or a location of each region of the current block.

17. The method according to claim 11, wherein the determining a target prediction block of the current block based on the first prediction block and the second prediction block comprises:
dividing the current block into a plurality of regions;
determining, for a first region in the plurality of regions, a weight value of the first prediction block in the first region and a weight value of the second prediction block in the first region; and
performing weighting processing on the first prediction block and the second prediction block in the first region by using the weight value of the first prediction block in the first region and the weight value of the second prediction block in the first region, to obtain a predicted value of the first region,
wherein the target prediction block comprises a predicted value of each region in the plurality of regions;
wherein the dividing the current block into a plurality of regions comprises:
dividing the first region into a plurality of regions based on the first prediction mode.

18. The method according to claim 11, wherein the template of the current block comprises at least one of a left reconstructed pixel, a lower left reconstructed pixel, an upper left reconstructed pixel, an upper reconstructed pixel, and an upper right reconstructed pixel of the current block.

19. The method according to claim 11, wherein the first prediction mode is a prediction mode obtained by template-based intra mode derivation TIMD.

20. A computer readable storage medium storing a computer program/instruction and a bitstream, wherein the computer program/instruction is executed by a processor to implement the encoding method according to claim 11 to generate the bitstream.
